(19) United States
(12) Patent Application Publication
(10) Pub. No.: US 2024/0140650 A1
(43) Pub. Date: May 2, 2024

(54) THERMOPLASTIC BAGS WITH LOFT CREATING REINFORCEMENT STRIPS

(71) Applicant: THE GLAD PRODUCTS COMPANY, Oakland, CA (US)

(72) Inventors: Edward B. Tucker, Yorkville, IL (US); Sarah J. Steenblock, Cincinnati, OH (US); Matthew W. Waldron, West Chester, OH (US)

(21) Appl. No.: 18/050,263

(22) Filed: Oct. 27, 2022

(51) Int. Cl. B65D 33/02; B32B 1/02; B32B 3/28; B32B 7/14; B32B 27/08; B65D 33/16; B65D 33/28

(52) U.S. Cl. CPC B65D 33/02; B32B 1/02; B32B 3/28; B32B 7/14; B32B 27/08; B65D 33/1691; B65D 33/28; B32B 2250/02; B32B 2272/00; B32B 2307/402; B32B 2307/54; B32B 2307/732; B32B 2439/06

(57) ABSTRACT

The present disclosure relates to a reinforced thermoplastic bag with lofted regions. In one or more embodiments, the reinforced thermoplastic bag includes a reinforced portion with lofted regions at a top-of-bag area where users often apply an external force to lift or carry the reinforced thermoplastic bag. In these or other embodiments, a reinforcing strip is positioned across one or both of a hem channel region and a grab zone along an outer surface, an inner surface, or between layers of the reinforced thermoplastic bag. In one or more embodiments, the lofted regions increase the loft of the reinforced thermoplastic bag, improve the feel of the reinforced thermoplastic bag, and/or modify a look of the reinforced thermoplastic bag.

### BACKGROUND

Among their many applications, thermoplastic bags are used as liners in trash or refuse receptacles. Such liners can be found at many locations from small household kitchen garbage cans to larger, multi-gallon drums located in public places and restaurants. Bags that are intended to be used as liners for such refuse containers are typically made from low-cost, pliable thermoplastic material. When the receptacle is full, the thermoplastic liner holding the trash can be removed for disposal and replaced with a new liner.

Increasing manufacturing costs for thermoplastic liners have led to a trending effort to decrease material usage (e.g., by making thinner webs). As a result, some conventional thermoplastic liners are prone to tearing, ruptures, and other issues, particularly at the top of the bag. For example, when grabbing conventional thermoplastic liners by a drawstring to pull the thermoplastic liner up and out of a trash receptacle, the weight of the trash combined with the upwards pulling force from the drawstring can cause a conventional thermoplastic liner to tear. Similarly, for instance, when grasping a conventional thermoplastic liner by a top portion, a grasping hand (e.g., fingers) can puncture or overly stretch (leading to subsequent failure of) the thermoplastic liner. In turn, such compromising of the top of the bag can lead to trash spillage, require an adjusted/awkward carrying position or method, etc.

For some conventional thermoplastic liners, the decrease in material can also trigger undesirable visual cues (e.g., that less material is used and therefore the thermoplastic liner must be weak or cheaply made). Regardless of actual material properties, these conventional thermoplastic liners can visually convey material properties indicative of low durability and strength.

### BRIEF SUMMARY

Aspects of the present disclosure relate to a reinforced thermoplastic bag with improved strength performance. In particular, one or more implementations of the reinforced thermoplastic bag include a reinforcing strip of thermoplastic material applied to at least a portion (e.g., a grab zone) of the thermoplastic bag. The reinforcing strip is discontinuously laminated to a thermoplastic sidewall of the thermoplastic bag and creates lofted regions in the thermoplastic bag. Specifically, in one or more implementations, the reinforcing strip is secured to the thermoplastic sidewall via contact areas. Furthermore, due to a tension differential between reinforcing strip and the thermoplastic sidewall when creating the contact areas, one of the reinforcing strip and the thermoplastic sidewall will pleat and provide loft regions when released from tension. The combination of the contact areas and the lofted regions reinforce the thermoplastic bag due to increased stiffness provided by the contact areas and the three-dimensional structure of the lofted regions, and thereby, help reduce tearing or other damage by stresses/strain from grasping fingers (e.g., during a grabbing motion to lift or carry) applied to the reinforced area. Additionally, the increased stiffness can provide a tactile feel that connotes strength to a user grasping the reinforced area. In one or more implementations, by positioning the reinforcing strip in the grab zone, (a high-touch area) the contact areas and lofted regions provide tactile cues to the consumer about the strength and quality of the thermoplastic bag.

One implementation of a reinforced thermoplastic bag includes first and second sidewalls extending between a first side edge and an opposing second side edge. A top opening is formed by the first and second sidewalls and the first and second sidewalls are connected along a bottom of the reinforced thermoplastic bag. A first reinforcing strip is discontinuously secured to the first sidewall by a first plurality of discontinuous lamination points. A first plurality of lofted regions, in one of the first reinforcing strip or the first sidewall, are between discontinuous lamination points of the first plurality of discontinuous lamination points. A second reinforcing strip is discontinuously secured to the second sidewall by a second plurality of discontinuous lamination points. A second plurality of lofted regions, in one of the second reinforcing strip or the second sidewall, are between discontinuous lamination points of the second plurality of discontinuous lamination points.

An implementation of a multi-layer thermoplastic bag includes an outer thermoplastic bag comprising first and second opposing sidewalls joined together along a first side edge, an opposite second side edge, an open first top edge, and a closed first bottom edge. The multi-layer thermoplastic bag also includes an inner thermoplastic bag positioned within the outer thermoplastic bag, the inner thermoplastic bag comprising third and fourth opposing sidewalls joined together along a third side edge, an opposite fourth side edge, an open second top edge, and a closed second bottom edge. A hem seal secures a fold-over of the open first top edge and the open second top edge forming a hem channel. A reinforcing strip is discontinuously secured to at least one of the outer thermoplastic bag or the inner thermoplastic bag by a plurality of discontinuous lamination points. A plurality of lofted regions, in at least one of the outer thermoplastic bag or the inner thermoplastic bag, are between discontinuous lamination points of the plurality of discontinuous lamination points.

Additionally, a method of manufacturing a reinforced thermoplastic bag involves providing a first thermoplastic film and a reinforcing strip. The method further involves creating a difference in tension between the first thermoplastic film and the reinforcing strip. The method also involves discontinuously laminating the reinforcing strip to the first thermoplastic film while the difference in tension exists between the first thermoplastic film and the reinforcing strip by creating discontinuous lamination points between the first thermoplastic film and the reinforcing strip by passing the first thermoplastic film and the reinforcing strip through contract rollers while the reinforcing strip is under greater tension than the first thermoplastic film to create contact areas between the first thermoplastic film and the reinforcing strip. Additionally, the method includes removing the difference in tension between the first thermoplastic film and the reinforcing strip thereby causing one of the first thermoplastic film or the reinforcing strip to pull portions of the other of the first thermoplastic film or the reinforcing strip between adjacent discontinuous lamination points together creating lofted regions. In addition to the foregoing, the method involves forming the first thermoplastic film with the reinforcing strip discontinuously laminated thereto into a bag.

Additional features and advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIG. 1A-1C show partial side cross-sectional views of films having varying numbers of layers in accordance with one or more implementations of the present disclosure;

FIG. 2A illustrates a side view of a thermoplastic film and a reinforcement strip prior to creating a difference in tension between the thermoplastic film and the reinforcement strip in accordance with one or more implementations of the present disclosure;

FIG. 2B illustrates a side view of the thermoplastic film and the reinforcement strip of FIG. 2A with a difference in tension created therebetween in accordance with one or more implementations of the present disclosure;

FIG. 2C illustrates a side view of a reinforced thermoplastic film with lofted regions created by discontinuously bonding the thermoplastic film and the reinforcement strip of FIG. 2B and then releasing the tension difference in accordance with one or more implementations of the present disclosure;

FIGS. 3A-3B show views of a set of contact rollers for forming contact areas in accordance with one or more implementations of the present disclosure;

FIG. 3C shows a perspective view of another set of contact rollers for forming contact areas in accordance with one or more implementations of the present disclosure;

FIG. 3D shows a perspective view of yet another set of contact rollers for forming contact areas in accordance with one or more implementations of the present disclosure;

FIG. 3E shows a view of a portion of a reinforced thermoplastic bag having contact areas created by the contract rollers of FIGS. 3A or 3C in accordance with one or more implementations of the present disclosure;

FIG. 4A illustrates a reinforced thermoplastic bag with lofted regions in accordance with one or more implementations of the present disclosure;

FIG. 4B illustrates another reinforced thermoplastic bag with lofted regions in accordance with one or more implementations of the present disclosure;

FIGS. 5A-5G illustrate respective upper cross-sectional views of sidewalls of reinforced thermoplastic bag with lofted regions in accordance with one or more implementations of the present disclosure;

FIG. 6 illustrates an example manufacturing process for forming a reinforced thermoplastic bag with lofted regions in accordance with one or more implementations of the present disclosure; and

FIG. 7 illustrates another example manufacturing process for forming a reinforced thermoplastic bag with lofted regions in accordance with one or more implementations of the present disclosure.

### DETAILED DESCRIPTION

This disclosure describes one or more embodiments of a reinforced thermoplastic bag with increased strength and effective gauge. In particular, the reinforced thermoplastic bag can include a reinforcement structure bonded to one or more sidewalls of the thermoplastic bag that creates loft, texture, and increased strength. In particular, one or more implementations involve creating a tension differential between the reinforcement strip and a thermoplastic film of a sidewall of the thermoplastic bag. While the tension differential is applied, a plurality of bonds are created between the reinforcement strip and the thermoplastic film. Upon releasing the tension differential, one of the reinforcement strip or the thermoplastic film will contract more than the other causing the other to gather creating lofted regions.

The lofted regions reduce web drape and add stiffness to the thermoplastic film/sidewall due to the three-dimensional structure of the lofted regions. Moreover, the lofted regions provide tactile cues connoting strength in addition to the increased stiffness. As such, the lofted regions provide both the look and feel of increased strength in one or more areas of the reinforced thermoplastic bag.

The reinforced thermoplastic bag can include a plurality of lofted regions. The lofted regions can be located between and maintained by adjacent lamination areas. A height of the lofted regions can be greater than a sum of the gauge of the films combining to form the lofted regions. Furthermore, the height of the lofted regions can be tailored based on the relative difference in strain applied to the films combining to form the lofted regions. In particular, the larger the difference in strain between the films (e.g., the reinforcement strip and one or more film layers of the bag sidewall) when they are bonded, the greater the height of the lofted regions. Thus, one or more implementations of the present invention allow for tailoring (e.g., increasing) of the height of the lofted regions independent of the basis weight (amount of raw material) of the reinforcement strip and one or more film layers of the bag sidewall. Thus, one or more implementations can provide reinforced bags with increased loft despite a reduction in thermoplastic material. As such, one or more implementations can reduce the material needed to produce a reinforced thermoplastic bag while maintaining or increasing the loft of the reinforced thermoplastic bag.

The lofted regions can comprise gaps between the reinforcement strip and sidewalls of the reinforced thermoplastic bag. The gaps of the lofted regions are air filled, and thus, provide the reinforced thermoplastic bag, in one or more implementations, with increased softness and a desirable look and feel.

Additionally, consumers may associate thinner films (e.g., films with decreased basis weight) with decreased strength. Indeed, consumers may feel that they are receiving less value for their money when purchasing thermoplastic bags with thinner gauges. One will appreciate in light of the disclosure herein that a consumer may not readily detect that one or more reinforced thermoplastic bags with lofted regions has a reduced basis weight. In particular, by increasing the loft of thermoplastic bags with thinner films, the consumer may perceive the reinforced thermoplastic bags with lofted regions as being thicker and/or having increased strength.

In addition to the foregoing, one or more implementations provide reinforced thermoplastic bags with lofted regions that consumers can associate with improved properties. For example, the lofted regions can indicate that those regions have undergone a transformation to impart a desirable characteristic to that region (e.g., increased strength or thicker feel). Thus, the lofted regions can serve to notify a consumer that the reinforced thermoplastic bags with lofted regions has been processed to improve the bag.

In addition to the foregoing, in one or more implementations, the lofted regions provide the reinforced thermoplastic bags with increased elasticity. In particular, the zones of the thermoplastic bag that are reinforced with lofted regions will concomitantly decrease in length in a direction parallel to the direction of straining prior to bonding. When a consumer applies a stretching force in this same direction, for instance when they place the top of the reinforced bag around the rim of a trash receptacle, the force required to strain the reinforced bag will be less than an identical laminate without the lofted regions. In particular, because the initial force required to stretch the reinforced bag is applied only, or substantially only, to the thermoplastic film that had greater strain at bonding (due to it being flat and un-lofted at rest), this thermoplastic film undergoes elongation upon application of tensile stress within the elastic portion of the stress-strain behavior. Simultaneously, the thermoplastic film with the lofted regions simply spreads out from a lofted morphology to a planar morphology prior to itself imparting resistance to the tensile stress being applied. Upon removal of the stretching force, the reinforced bag elastically returns to its condition at rest, being shorter in length. This feature can make provide a reinforced area with lofted regions an ability to a grip a trash can.

In one or more embodiments, the reinforcement strip and associated lofted regions comprises one or more thermoplastic films that that reinforces one or more zones of a reinforced thermoplastic bag. For example, in one or more implementation, the reinforcement strip and associated lofted regions reinforces a hem channel. Thus, when cinching a draw tape (or carrying the trash bag by the draw tape) disposed within the hem channel, the reinforcement strip and associated lofted regions reduces/prevents tearing of the hem (e.g., along hem holes for accessing the draw tape). Additionally, or alternatively, the reinforcement strip and associated lofted regions is positioned across, and reinforces, a grab zone below a hem seal (e.g., to prevent grasping fingers from damaging the reinforced thermoplastic bag). For example, in one or more implementations, at least a portion of the reinforcement strip and associated lofted regions is positioned across an inside surface and/or across an outside surface of the reinforced thermoplastic bag. Additionally, or alternatively, at least a portion of the reinforcement strip and associated lofted regions is positioned between layers of the reinforced thermoplastic bag.

In one or more embodiments, the reinforcement strip and associated lofted regions comprises a single layer of reinforcing material across a grab zone of the reinforced thermoplastic bag. The single layer of reinforcing material can be advantageous because a single reinforcing layer reduces additional manufacturing operations and additional material consumption while nonetheless providing positionally-targeted strength and durability. For instance, the single layer of reinforcing material may span from a hem seal (where secured) down towards a bottom fold (e.g., for at least 2-3 inches). In other embodiments, the single layer of reinforcing material is even more manufacture friendly by being secured to the reinforced thermoplastic bag independent of a hem seal and extending from proximate the hem seal down towards the bottom fold for a predetermined distance.

In one or more implementations, the reinforcement strip and associated lofted regions is colored or patterned to visually impart or increase a perception of strength and durability to the reinforced zones of the thermoplastic bag. In these or other embodiments, one or more layers of the reinforced thermoplastic bag are translucent to facilitate visibility of the reinforcement strip when positioned between layers or across an inside layer of the reinforced thermoplastic bag. For example, when superimposing a translucent outer layer of reinforced thermoplastic bag over one or more colored portions of the reinforcement strip, the reinforced thermoplastic bag can visibly show that the grab zone is a reinforced area.

As illustrated by the foregoing discussion, the present disclosure utilizes a variety of terms to describe features and benefits of a reinforced thermoplastic bag. Additional detail is now provided regarding the meaning of these terms. For example, As used herein, the term “grab zone” refers to a portion of a thermoplastic bag that is subjected to an applied load (e.g., a lifting force to lift or carry the thermoplastic bag). In particular, the grab zone includes a top portion of a thermoplastic bag (e.g., above and/or below a hem seal). For example, the grab zone extends from a first side edge to an opposing second side edge and from proximate (e.g., immediately adjacent to or within a threshold distance from) the top opening a first distance toward the bottom fold. As another example, the grab zone extends from a first side edge to an opposing second side edge and from the hem seal a second distance (equivalent or different from the first distance) toward the bottom fold. As a further example, the grab zone extends from a first side edge to an opposing second side edge and from the hem seal a third distance (equivalent or different from the first and second distances) to a hem skirt seal toward the bottom fold.

As used herein, the terms “lamination,” “laminate,” and “laminated film,” refer to the process and resulting product made by bonding together two or more layers of film or other material. The term “bonding,” when used in reference to bonding of multiple layers of a reinforced thermoplastic bag, may be used interchangeably with “lamination” of the layers. According to one or more implementations, adjacent films of a reinforced thermoplastic bag are laminated or bonded to one another.

The term laminate is also inclusive of coextruded multilayer films comprising one or more tie layers. As a verb, “laminate” means to affix or adhere (by means of, for example, adhesive bonding, pressure bonding, ultrasonic bonding, corona lamination, heat bonding, and the like) two or more separately made film articles to one another so as to form a reinforced thermoplastic bag. As a noun, “laminate” means a product produced by the affixing or adhering just described.

In one or more implementations, the contact areas between films of a reinforced thermoplastic bag may be continuous. As used herein, a “continuous” area of contact areas refers to one or more contact areas that are continuously positioned in an area, and arranged in the machine direction, in the transverse direction, or in an angled direction.

In one or more implementations, the contact areas between films of a reinforced thermoplastic bag may be in a discrete or non-continuous pattern (i.e., discontinuous or partially discontinuous). As used herein, a “discrete pattern” of contact areas refers to a non-repeating pattern of pattern elements in the machine direction, in the transverse direction, or in an angled direction.

In one or more implementations, the contact areas between films of a reinforced thermoplastic bag may be in a partially discontinuous pattern. As used herein, a “partially discontinuous” pattern of contact areas refers to pattern elements that are substantially continuous in the machine direction or in the transverse direction, but not continuous in the other of the machine direction or the transverse direction. Alternately, a partially discontinuous pattern of contact areas refers to pattern elements that are substantially continuous in the width of the article but not continuous in the height of the article, or substantially continuous in the height of the article but not continuous in the width of the article. Alternatively, a partially discontinuous pattern of contact areas refers to pattern elements that are substantially continuous for a width and height that is less than the width and height of the article. More particularly, a partially discontinuous pattern of contact areas refers to repeating pattern elements broken up by repeating separated areas in either the machine direction, the transverse direction, or both. Both partially discontinuous and discontinuous patterns are types of non-continuous heated pressure bonding (i.e., bonding that is not complete and continuous between two surfaces).

One or more implementations involve bringing pigmented, lightly pigmented, and/or substantially un-pigmented thermoplastic films into intimate contact. As used herein, the term “substantially un-pigmented” refers to a thermoplastic ply or plies that are substantially free of a significant amount of pigment such that the ply is substantially transparent or translucent. For example, a “substantially un-pigmented” film can have a pigment concentration (i.e., percent of total composition of the film) that is between 0% by weight and 2% by weight. In some embodiments, a “substantially un-pigmented” film can have a pigment concentration between about 0% by weight and about 1% by weight. In further embodiments, a “substantially un-pigmented” film can have a pigment concentration between about 0% by weight and about 0.75% by weight. A substantially un-pigmented film can have a transparent or translucent appearance.

As used herein, the term “lightly pigmented” refers to a thermoplastic ply or plies that are pigmented such that, when placed into intimate contact with a pigmented film, an unexpected appearance is produced. For example, the unexpected appearance can be a “wetting” of a color of the pigmented film through the lightly pigmented film. Alternately, the unexpected appearance may be an effect that differs from an appearance (e.g., colors) of the individual films. If a film has too much pigment, when placed into intimate contact with another pigmented film, an unexpected appearance will not be produced. The amount of pigment in a lightly pigmented film that will produce the unexpected appearance can be dictated by the thickness of the film.

A pigmented film can comprise a lightly pigmented film or a film with a greater percentage of pigment than a lightly pigmented film. As mentioned above, in one or more embodiments, a first thermoplastic film is substantially un-pigmented or lightly pigmented and a second thermoplastic film is pigmented. Thus, in one or more embodiments, the second thermoplastic layer has a greater percentage of pigment than the first thermoplastic layer. Alternatively, the first and second thermoplastic layers have the same percentage of pigment but the first thermoplastic layer comprises a lighter pigment than a pigment of the second thermoplastic layer.

As used herein, the term “pigment or pigments” are solids of an organic and inorganic nature which are defined as such when they are used within a system and incorporated into the thermoplastic film, absorbing part of the light and reflecting the complementary part thereof which forms the color of the thermoplastic ply. Representative, but not limiting, examples of suitable pigments include inorganic colored pigments such as such as iron oxide, in all their shades of yellow, brown, red and black; and in all their physical forms and particle-size categories, chromium oxide pigments, also co-precipitated with nickel and nickel titanates, blue and green pigments derived from copper phthalocyanine, also chlorinated and brominated in the various alpha, beta and epsilon crystalline forms, yellow pigments derived from lead sulphochromate, yellow pigments derived from lead bismuth orange pigments derived from lead sulphochromate molybdate lead oxide, cadmium sulfide, cadmium selenide, lead chromate, zinc chromate, nickel titanate, and the like. For the purposes of the present invention, the term “organic pigment” comprises also black pigments resulting from organic combustion (so-called “carbon black”). Organic colored pigments include yellow pigments of an organic nature based on arylamides, orange pigments of an organic nature based on naphthol, orange pigments of an organic nature based on diketo-pyrrolo-pyrole, red pigments based on manganese salts of azo dyes, red pigments based on manganese salts of beta-oxynaphthoic acid, red organic quinacridone pigments, and red organic anthraquinone pigments. Organic colored pigments include azo and diazo pigments, phthalocyanines, quinacridone pigments, perylene pigments, isoindolinone, anthraquinones, thioindigo, solvent dyes and the like.

Pigments can be light reflecting (e.g., white pigments) or light absorbing (e.g., black pigments). Examples of pigments suitable for one or more implementations include titanium dioxide, Antimony Oxide, Zinc Oxide, White Lead, Lithopone, Clay, Magnesium Silicate, Barytes (BaSO4), and Calcium Carbonate (CaCO3).

### Film Materials

As an initial matter, the thermoplastic material of the films of one or more implementations of the present disclosure may include thermoplastic polyolefins, including polyethylene and copolymers thereof and polypropylene and copolymers thereof. The olefin-based polymers may include ethylene or propylene-based polymers such as polyethylene, polypropylene, and copolymers such as ethylene vinyl acetate (EVA), ethylene methyl acrylate (EMA) and ethylene acrylic acid (EAA), or blends of such polyolefins.

Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

Other examples of polymers suitable for use as films in accordance with the present invention include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), poly(ethylene butylacrylate), polyurethane, poly(ethylene-propylene-diene), ethylene-propylene rubber, and combinations thereof. Suitable biodegradable polymers include, for example, aliphatic polyesters, such as polycaprolactone, polyesteramides, polylactic acid (PLA) and its copolymers, polyglycolic acid, polyalkylene carbonates (e.g., polyethylene carbonate), poly-3-hydroxybutyrate (PHB), poly-3-hydroxyvalerate (PHV), poly-3-hydroxybutyrate-co-4-hydroybutyrate, poly-3-hydroxybutyrate-co-3-hydroxyvalerate copolymers (PHBV), poly-3-hydroxybutyrate-co-3-hydroxyhexanoate, poly-3-hydroxybutyrate-co-3-hydroxyoctanoate, poly-3-hydroxybutyrate-co-3-hydroxydecanoate, poly-3-hydroxybutyrate-co-3-hydroxyoctadecanoate, and succinate-based aliphatic polymers (e.g., polybutylene succinate, polybutylene succinate adipate, polyethylene succinate, etc.); aliphatic-aromatic copolyesters (e.g., polybutylene adipate terephthalate, polyethylene adipate terephthalate, polyethylene adipate isophthalate, polybutylene adipate isophthalate, etc.); aromatic polyesters (e.g., polyethylene terephthalate, polybutylene terephthalate, etc.); and combinations thereof.

Some of the examples and description herein below refer to films formed from linear low-density polyethylene. The term “linear low-density polyethylene” (LLDPE) as used herein is defined to mean a copolymer of ethylene and a minor amount of an olefin containing 4 to 10 carbon atoms, having a density of from about 0.910 to about 0.930, and a melt index (MI) of from about 0.5 to about 10. For example, some examples herein use an octene comonomer, solution phase LLDPE (MI=1.1; p=0.920). Additionally, other examples use a gas phase LLDPE, which is a hexene gas phase LLDPE formulated with slip/AB (MI=1.0; p=0.920). Still further examples use a gas phase LLDPE, which is a hexene gas phase LLDPE formulated with slip/AB (MI=1.0; p=0.926). One will appreciate that the present disclosure is not limited to LLDPE and can include “high density polyethylene” (HDPE), “low density polyethylene” (LDPE), and “very low-density polyethylene” (VLDPE). Indeed, films made from any of the previously mentioned thermoplastic materials or combinations thereof can be suitable for use with the present disclosure.

Some implementations of the present disclosure may include any flexible or pliable thermoplastic material that may be formed or drawn into a web or film. Furthermore, the thermoplastic materials may include a single layer or multiple layers. The thermoplastic material may be opaque, transparent, translucent, or tinted. Furthermore, the thermoplastic material may be gas permeable or impermeable.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and bags that are flexible, therefore, may be altered in shape and structure to accommodate external forces and to conform to the shape of objects brought into contact with them without losing their integrity. In accordance with further prior art materials, web materials are provided which exhibit an “elastic-like” behavior in the direction of applied strain without the use of added traditional elastic materials. As used herein, the term “elastic-like” describes the behavior of web materials which when subjected to an applied strain, the web materials extend in the direction of applied strain, and when the applied strain is released the web materials return, to a degree, to their pre-strained condition.

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 70.0% met, at least 80.0%, at least 90% met, at least 95.0% met, at least 99.0% met, or even at least 99.9% met.

Additional additives that may be included in one or more implementations include slip agents, anti-block agents, voiding agents, or tackifiers. Additionally, one or more implementations of the present disclosure include films that are devoid of voiding agents. Some examples of inorganic voiding agents, which may further provide odor control, include the following but are not limited to calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

One of ordinary skill in the art will appreciate in view of the present disclosure that manufacturers may form the films or webs to be used with the present disclosure using a wide variety of techniques. For example, a manufacturer can form precursor mix of the thermoplastic material and one or more additives. The manufacturer can then form the film(s) from the precursor mix using conventional flat or cast extrusion or co-extrusion to produce monolayer, bilayer, or multilayer films. Alternatively, a manufacturer can form the films using suitable processes, such as, a blown film process to produce monolayer, bilayer, or multilayer films. If desired for a given end use, the manufacturer can orient the films by trapped bubble, tenterframe, or other suitable process. Additionally, the manufacturer can optionally anneal the films thereafter.

An optional part of the film-making process is a procedure known as “orientation.” The orientation of a polymer is a reference to its molecular organization, i.e., the orientation of molecules relative to each other. Similarly, the process of orientation is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process can require different procedures. This is related to the different physical characteristics possessed by films made by conventional film-making processes (e.g., casting and blowing). Generally, blown films tend to have greater stiffness and toughness. By contrast, cast films usually have the advantages of greater film clarity and uniformity of thickness and flatness, generally permitting use of a wider range of polymers and producing a higher quality film.

When a film has been stretched in a single direction (mono-axial orientation), the resulting film can exhibit strength and stiffness along the direction of stretch, but can be weak in the other direction, i.e., across the stretch, often splitting when flexed or pulled. To overcome this limitation, two-way or biaxial orientation can be employed to more evenly distribute the strength qualities of the film in two directions. Most biaxial orientation processes use apparatus that stretches the film sequentially, first in one direction and then in the other.

In one or more implementations, the films of the present disclosure are blown film, or cast film. Both a blown film and a cast film can be formed by extrusion. The extruder used can be a conventional one using a die, which will provide the desired gauge. Some useful extruders are described in U.S. Pat. Nos. 4,814,135; 4,857,600; 5,076,988; 5,153,382; each of which are incorporated herein by reference in their entirety. Examples of various extruders, which can be used in producing the films to be used with the present disclosure, can be a single screw type modified with a blown film die, an air ring, and continuous take off equipment.

In one or more implementations, a manufacturer can use multiple extruders to supply different melt streams, which a feed block can order into different channels of a multi-channel die. The multiple extruders can allow a manufacturer to form a film with layers having different compositions. Such reinforced thermoplastic bag may later be provided with a complex stretch pattern to provide the benefits of the present disclosure.

In a blown film process, the die can be an upright cylinder with a circular opening. Rollers can pull molten thermoplastic material upward away from the die. An air-ring can cool the film as the film travels upwards. An air outlet can force compressed air into the center of the extruded circular profile, creating a bubble. The air can expand the extruded circular cross section by a multiple of the die diameter. This ratio is called the “blow-up ratio.” When using a blown film process, the manufacturer can collapse the film to double the plies of the film. Alternatively, the manufacturer can cut and fold the film, or cut and leave the film unfolded.

In any event, in one or more implementations, the extrusion process can orient the polymer chains of the blown film. The “orientation” of a polymer is a reference to its molecular organization, i.e., the orientation of molecules or polymer chains relative to each other. In particular, the extrusion process can cause the polymer chains of the blown film to be predominantly oriented in the machine direction. The orientation of the polymer chains can result in an increased strength in the direction of the orientation. As used herein predominately oriented in a particular direction means that the polymer chains are more oriented in the particular direction than another direction. One will appreciate, however, that a film that is predominately oriented in a particular direction can still include polymer chains oriented in directions other than the particular direction. Thus, in one or more implementations the initial or starting films (films before being stretched or bonded or laminated in accordance with the principles described herein) can comprise a blown film that is predominately oriented in the machine direction.

The process of blowing up the tubular stock or bubble can further orient the polymer chains of the blown film. In particular, the blow-up process can cause the polymer chains of the blown film to be bi-axially oriented. Despite being bi-axially oriented, in one or more implementations the polymer chains of the blown film are predominantly oriented in the machine direction (i.e., oriented more in the machine direction than the transverse direction).

The films of one or more implementations of the present disclosure can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.4 mils and about 0.6 mils. Additionally, the starting gauge of films of one or more implementations of the present disclosure may not be uniform. Thus, the starting gauge of films of one or more implementations of the present disclosure may vary along the length and/or width of the film.

As described above, a reinforced thermoplastic bag includes a plurality of thermoplastic films. Each individual film may itself include a single layer or multiple layers. In other words, the individual films of the reinforced thermoplastic bag may each themselves comprise a plurality of layers. Such layers may be significantly more tightly bonded together than the bonding (if any) of the contact areas. Both tight and relatively weak bonding can be accomplished by joining layers by mechanical pressure, joining layers with heat, joining with heat and pressure, joining layers with adhesives, spread coating, extrusion coating, ultrasonic bonding, static bonding, cohesive bonding and combinations thereof. Adjacent sub-layers of an individual film may be coextruded. Co-extrusion results in tight bonding so that the bond strength is greater than the tear resistance of the resulting laminate (i.e., rather than allowing adjacent layers to be peeled apart through breakage of the lamination bonds, the film will tear).

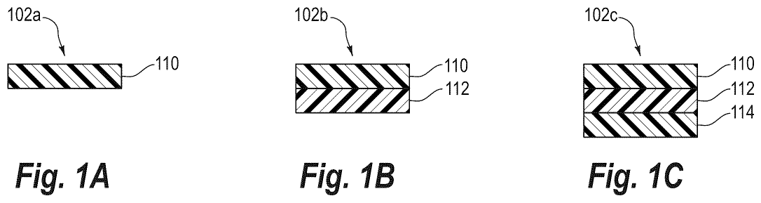

A thermoplastic film can may include a one, two, three, or more layers of thermoplastic material. FIGS. 1A-1C are partial cross-sectional views of films that can be included in a reinforced thermoplastic bag of one or more implementations. In some implementations, the film may include a single layer film 102a, as shown in FIG. 1A, comprising a single first layer 110. In other embodiments, the film can comprise a two-layer film 102b as shown in FIG. 1B, including the first layer 110 and a second layer 112. The first and second layers 110, 112 can be coextruded. In such implementations, the first and second layers 110, 112 may optionally include different grades of thermoplastic material and/or include different additives, including polymer additives and/or pigments. In yet other implementations, a film be a tri-layer film 102c, as shown in FIG. 1C, including the first layer 110, the second layer 112, and a third layer 114. In yet other implementations, a film may include more than three layers. The tri-layer film 102c can include an A:B:C configuration in which all three layers vary in one or more of gauge, composition, color, transparency, or other properties. Alternatively, the tri-layer film 102c can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios.

In one example, the film 102a can comprise a 0.5 mil, 0.920 density LLDPE, colored film containing 4.8% pigment that appears a first color. In an alternative embodiment, the film 102a can comprise a 0.5 mil, 0.920 density LLDPE, un-pigmented film that appears clear or substantially clear. In still further embodiments, the film 102a can comprise a 0.5 mil, 0.920 density LLDPE, pigmented film that appears a second color.

In at least one implementation, such as shown in FIG. 1C, a multilayered film 102c can include co-extruded layers. For example, the film 102c can include a three-layer B:A:B structure, where the ratio of layers can be 20:60:20. The exterior B layers (i.e., the first layer 110, and the third layer 114) can comprise a mixture of hexene LLDPE of density 0.918, and metallocene LLDPE of density 0.920. The interior A core layer (i.e., the second layer 112) can comprise a mixture of hexene LLDPE of density 0.918, butene LLDPE of density 0.918, reclaimed resin from trash bags. Additionally, the A core layer (i.e., the second layer 112) can include a pigment. For example, the A core layer can include a colorant in an amount between about 0.1 percent and about 6%.

In another example, the film 102c is a coextruded three-layer B:A:B structure where the ratio of layers is 15:70:15. The B:A:B structure can also optionally have a ratio of B:A that is greater than 20:60 or less than 15:70. In one or more implementations, the LLDPE can comprise greater than 50% of the overall thermoplastic material in the film 102c.

In another example, the film 102c is a coextruded three-layer C:A:B structure where the ratio of layers is 20:60:20. The C layer (i.e., the third layer 114) can comprise a LLDPE material with a first colorant (e.g., black). The B layer (i.e., the second layer 112) can also comprise a LLDPE material with a second colorant (e.g., white). The LLDPE material can have a MI of 1.0 and density of 0.920 g/cm3. The A core layer (i.e., the first layer 110) can comprise similar materials to any of the core layer describe above. The A core layer can comprise a black colorant, a white colorant, or can be clear.

In still further embodiments, a film can comprise any number of co-extruded layers. More particularly in one or more embodiments, a film can comprise any number of co-extruded layers so long as the A and B layers do not alternate such that the A layers are on one side and the B layers are on the other side. In still further embodiments, a film can comprise one or more co-extruded layers between the A and B layers. For example, the film can comprise clear or transparent layers between the A and B layer(s). In still further embodiments, a film can comprise intermittent layers of different colors in addition to the A and B layer(s).

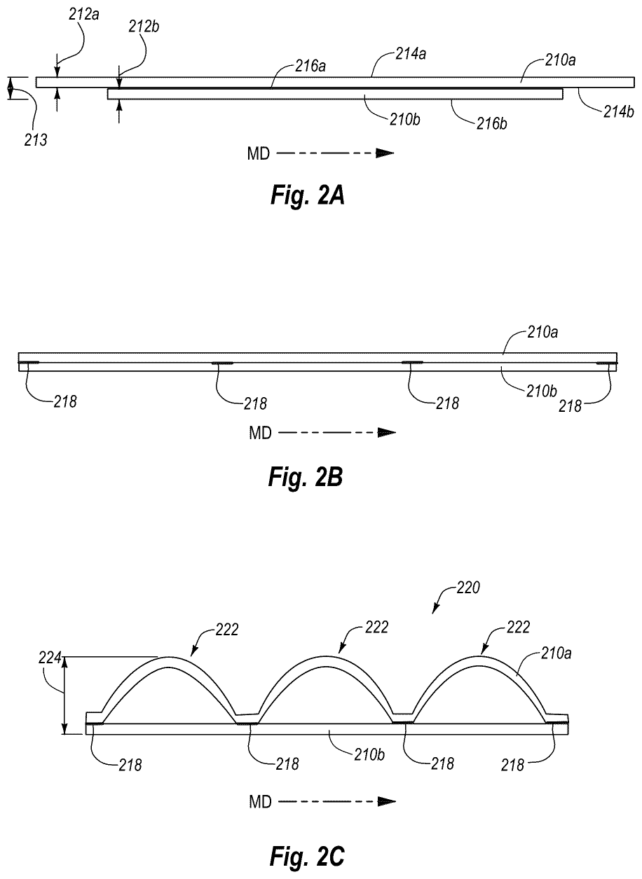

Referring now to the Figures, FIGS. 2A-2C illustrate one implementation of a process of differentially straining, non-continuously bonding, and releasing a pair of thermoplastic films to create lofted regions. As previously mentioned, the lofted regions increase the loft of the multi-film structure (e.g., a reinforcing strip and a thermoplastic film of a sidewall of a thermoplastic bag). In particular, FIG. 2A illustrates a first thermoplastic film 210a with a first starting gauge 212a and a second thermoplastic film 210b with a second starting gauge 212b. Together the first and second thermoplastic films 210a, 210b can have an initial loft 213. As used herein, the term “loft” refers to the largest distance between the outer major surfaces of a film. Thus, the combined loft 213 of the first and second thermoplastic films 210a, 210b is equal to the sum of the starting gauge 212a and the starting gauge 212b.

In one or more implementations, prior to straining, the first and second thermoplastic films 210a, 210b can have substantially flat top surfaces 214a, 216a and substantially flat bottom surfaces 214b, 216b. In at least one implementation, the starting gauges 212a, 212b can be substantially uniform along the length of the first and second thermoplastic films 210a, 210b. For purposes of the one or more implementations, the first and second thermoplastic films 210a, 210b need not have an entirely flat top or bottom surfaces. Indeed, the top and/or bottom surfaces can be rough or uneven. Further, the starting gauges 212a, 212b need not be consistent or uniform throughout the entirety of the first and second thermoplastic films 210a, 210b. Thus, the starting gauges 212a, 212b can vary due to intentional product design, manufacturing defects, tolerances, or other processing inconsistencies. The films of one or more implementations of the present invention can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.4 mils and about 0.6 mils.

The individual films or layers (e.g., first and second thermoplastic films 210a, 210b) can comprise any of the films described above in relation to FIGS. 1A-1C. In particular, one or more of the first and second thermoplastic films 210a, 210b can comprise two, three, four, or more coextruded, or otherwise bonded, layers. For ease in description, the first and second thermoplastic films 210a, 210b are described and shown herein as single film layers. One will appreciate, however, that the present invention is not so limited, and the first and second thermoplastic films 210a, 210b can each include one, two, three, or more layers.

As alluded to earlier, one or more implementations involves differentially straining the first thermoplastic film 210a relative to the second thermoplastic film 210b. In particular, creating differential strain can involve stretching the first thermoplastic film 210a a different amount than the second thermoplastic film 210b. For example, in one or more implementations, a reinforcing strip is strained or stretched more than a thermoplastic film (e.g., layer of a sidewall). Alternatively, in one or more implementations, a reinforcing strip is strained or stretched less than a thermoplastic film (e.g., layer of a sidewall).

As previously mentioned, one or more implementations include stretching one or more of the first and second thermoplastic films 210a, 210b. For example, FIG. 2B illustrates the second thermoplastic film 210b stretched to increase its length. A manufacturer can also optionally stretch the first thermoplastic film 210a to a differing degree as the second thermoplastic film 210b. Alternatively, the first thermoplastic film 210a can remain unstretched so long as the first and second thermoplastic films 210a, 210b have differing strain applied. One will appreciate in light of the disclosure herein that any of machine-direction orientation, tentering, MD ring rolling, TD ring rolling, diagonal direction (“DD”) ring rolling, a structural elastic like film process (“SELFing”), embossing, other stretching methods, or combinations thereof may be used to stretch one or more of the first and second thermoplastic films 210a, 210b.

After stretching one or more of the first and second thermoplastic films 210a, 210b, a manufacturer can non-continuously laminate the first and second thermoplastic films 210a, 210b together. For example, FIG. 2B illustrates the first thermoplastic film 210a discontinuously bonded to the second thermoplastic film 210b by a plurality of bonding points 218. In particular, the bonding points 218 extend discontinuously between the first and second films 210a, 210b in the transverse direction and in the machine direction. As shown by FIG. 2B, the bonding points 218 are uniformly spaced across the first and second thermoplastic films 210a, 210b. In alternative implementations, the bonding points 218 can be regularly or irregularly spaced. One will appreciate that the pattern or configuration of the bonding points 218 can depend upon the technique used to laminate the first and second thermoplastic films 210a, 210b.

A manufacturer can use one or more suitable techniques to non-continuously laminate the first and second thermoplastic films 210a, 210b together. For example, a manufacturer can use pressure (for example MD ring rolling, TD ring rolling, stainable network lamination, or embossing), or a combination of heat and pressure. Alternately, a manufacturer can use ultrasonic bonding. Still further, a manufacturer can use adhesives to laminate the first and second thermoplastic films 210a, 210b together. Treatment with a Corona discharge can enhance any of the above methods. As explained in greater detail below, in one or more implementations involve creating contact areas to discontinuously bond or laminate the first and second thermoplastic films 210a, 210b together.

As shown, at the time of bonding, a length of the first and second thermoplastic films 210a, 210b between adjacent bonding points 218 is equal, or approximately equal. After releasing the applied strain, the second thermoplastic film 210b contracts more than the first thermoplastic film 210a. Due to this difference in rebound, a length of the first thermoplastic film 210a between adjacent bonding points 218 is longer than a length of the second thermoplastic film 210b between adjacent bonding points 218. In order to accommodate the difference in length, the first thermoplastic film 210a billows to create the lofted regions 222 with heights 224.

FIG. 2C illustrates one example of a portion of a sidewall of a reinforced thermoplastic bag having lofted regions 222. As mentioned, the bonding points 218 can be formed using a number of different techniques. In at least one implementation, the bonding points 218 comprise contact areas between the first thermoplastic film 210a and a second thermoplastic film 210b. FIG. 2C illustrates that the first thermoplastic film 210a is secured to the second thermoplastic film 210b via contact areas 218. In particular, reinforced thermoplastic bag having lofted regions 222 can include contact areas 218 and lofted regions 222. The contact areas 218 remove the air and/or space between the thermoplastic films 210a, 210b.

As shown by FIG. 2C, the contact areas 218 can comprise areas in which the first thermoplastic film 210a is in direct, or intimate, contact with the second thermoplastic film 210b. As such, the contact areas 218 can create regions that are visually distinct from the rest of the reinforced thermoplastic bag 220 (at least when viewing the major surface of the first thermoplastic film 210a). In other words, because the first thermoplastic film 210a is directly abutted against the second thermoplastic film 210b, the contact areas 218 can have the color or appearance of the second thermoplastic film 210b or another color or appearance that differs from the separated portions of the first thermoplastic film 210a.

For example, in one or more implementations, the second thermoplastic film 210b can comprise a pigmented film and have a black appearance while the first thermoplastic film 210a is substantially un-pigmented or lightly pigmented and have a clear, transparent, or cloudy appearance. When combined to form a reinforced thermoplastic bag 220 in accordance the principles described herein, the first thermoplastic film 210a as part of the reinforced thermoplastic bag 220 can have a color or appearance that differs from the color of the first thermoplastic film 210a. For example, the first thermoplastic film 210a can have a metallic, silvery metallic or light grey color rather than a black appearance or color as would be expected (i.e., due to viewing the second thermoplastic film 210b through a clear or transparent film). The regions or areas of the two films in intimate contact with each other create contact areas that have a color or appearance that differs from the color or appearance of the first thermoplastic film 210a. For example, the contact areas 218 can have the color or appearance of the second thermoplastic film 210b (e.g., black).

In one or more alternative implementations, the first thermoplastic film 210a comprises a light colorant while the second thermoplastic film 210b comprises a dark colorant. As used herein, a light colorant is a color with a brightness closer to the brightness of white than the brightness of black. As used herein, a dark colorant is a color with a brightness closer to the brightness of black than the brightness of white. In one or more embodiments, the first thermoplastic film 210a has a concentration of light colorant between about 1% by mass and about 15% by mass. More particularly, in one or more embodiments, the first thermoplastic film 210a has a concentration of light colorant between about 2% by mass and about 12% by mass. In still further embodiments, the first thermoplastic film 210a has a concentration of light colorant between about 5% by mass and about 10% by mass.

Still further, the second thermoplastic film 210b has a concentration of dark colorant between about 1% by mass and about 15% by mass. More particularly, in one or more embodiments, the second thermoplastic film 210b has a concentration of dark colorant between about 2% by mass and about 12% by mass. In still further embodiments, the second thermoplastic film 210b has a concentration of dark colorant between about 5% by mass and about 10% by mass.

The white colored first thermoplastic film 210a, when part of the reinforced thermoplastic bag 220 can have a gray appearance. The foregoing described color change may give the appearance of a third color without requiring the actual colorant mixture of the third color to be within the reinforced thermoplastic bag. In other words, the bag can be devoid of a gray pigment. For example, it may allow a film having a viewable black layer and a viewable white layer to have (i.e., mimic) a gray appearance (often a consumer preferred color). Furthermore, the foregoing described color change may allow the film to mimic a gray appearance without significantly increasing and/or reducing a transparency (i.e., light transmittance) of the film. In other words, the foregoing described color change may allow the reinforced thermoplastic bag 220 to mimic a gray appearance without detrimentally affecting an appearance of quality of the film.

Thus, the contact areas have a color or appearance that differs from the color or appearance of the first thermoplastic film 210a. For example, the contact areas 218 can have the color or appearance of the second thermoplastic film 210b (e.g., black) or another color. One will appreciate in light of the disclosure herein that black and white are used as exemplary colors for ease in explanation. In alternative embodiments, the films can comprise other color combinations such as white and blue, yellow and blue, red and blue, etc.

Irrespective of the specific colors of the first and second thermoplastic films, the contact areas 218 can have a substantial change in appearance compared to the lofted regions 222 when viewed from the first thermoplastic film side of the reinforced thermoplastic bag. In some embodiments, for example, when using the LAB color space, a represents a measurement of green and magenta values, b represents a measurement of blue and yellow values, and L represents a measurement of lightness (i.e., white and back values). In some embodiments, the change in appearance of the contact areas 218 comprises a color change in which the L value decreases by at least five points. In some embodiments, the change in appearance of the contact areas 218 comprises a color change in which the L value decreases between five and forty points, between five and thirty points, or between five and twenty points.

For example, the change in appearance of the contact areas 218 may include a perceivable change of color from gray to black. In additional embodiments, the change in appearance of the contact areas 218 may include a perceivable change of color from a first relatively lighter color to a second darker color. For example, the change in appearance may include perceivable change of color from a first light gray to a second dark gray. In other implementations, the change in appearance may include perceivable change of color from a first lighter version of any color to a second darker version of the same color.

As another example, it may allow a film having a viewable blue layer (with a back yellow layer) to have (i.e., mimic) a green appearance. Furthermore, the foregoing described color change may allow the film to mimic a green appearance without significantly increasing and/or reducing a transparency (i.e., light transmittance) of the film. In other words, the foregoing described color change may allow the film to mimic a green appearance without detrimentally affecting an appearance of quality of the film. As a result of the foregoing, the multi-layer film of the present disclosure may provide a multi-layer film having a particular appearance (e.g., a green appearance) while reducing costs. One will appreciate that other color combination in addition to white/black producing grey and yellow/blue producing green are possible and the foregoing are provided by way of example and not limitation.

FIG. 2C further illustrates that the contact areas 218 secure the thermoplastic films 210a, 210b of the reinforced thermoplastic bag 220 such that the thickness of the thermoplastic films 210a, 210b is substantially unchanged at each of the contact areas 218. In other words, each of the first and second thermoplastic films 210a, 210b can have a substantially uniform gauge (e.g., are substantially flat). In other words, the gauge of the first and second thermoplastic films 210a, 210b in the lofted regions 222 is substantially the same as the gauge of the first and second thermoplastic films 210a, 210b in the contact areas 218. This is in contrast to ring rolled, SELF'ed, conventional embossing, or other processes that can bond film layers together, while also deforming portions of the films. As mentioned above, the heat, pressure, and depth of engagement during creation of the contact areas can control to what extent, if any, the thermoplastic films are deformed when forming the contact areas 218. In one or more implementations, the process of forming the contact areas 218 does not deform, or does not substantially deform, the thermoplastic films such that they are flat, or appear flat, despite the presence of contact areas 218. In alternative implementations, the portions of the first and second thermoplastic films comprising the contact areas 218 create an increase or decrease in the gauge or loft 213.

In one or more implementations, the creation of the contact areas 218 does not weaken the first and second thermoplastic films 210a, 210b. For example, in one or more implementations, film strength in the portions of the first and second thermoplastic films 210a, 210b comprising the contact areas 218 is not significantly lower than the portions of the first and second thermoplastic films 210a, 210b in the lofted regions 222. In particular, in one or more implementations, film in the contact areas 218 have transverse direction tensile strength that is the same as the film in the lofted regions 222.

Moreover, the creation of the contact areas 218 can create other tactile features in the reinforced thermoplastic bag 220. For example, regions of the reinforced thermoplastic bag 220 including the contact areas 218 can have an increased rigidity over other regions of the reinforced thermoplastic bag 220 without contact areas. In some implementations, the contact areas 218 may increase the rigidity of the reinforced thermoplastic bag 220 by doubling the rigidity. In other implementations, the contact areas 218 may increase the rigidity of the reinforced thermoplastic bag 220 by as much as a factor of three. Alternatively, the contact areas 218 may not increase the rigidity of the reinforced thermoplastic bag 220 at all.

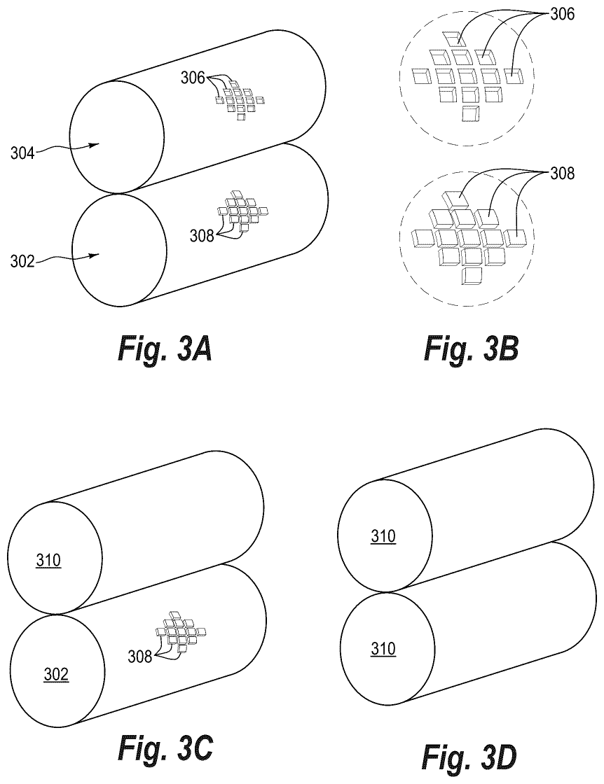

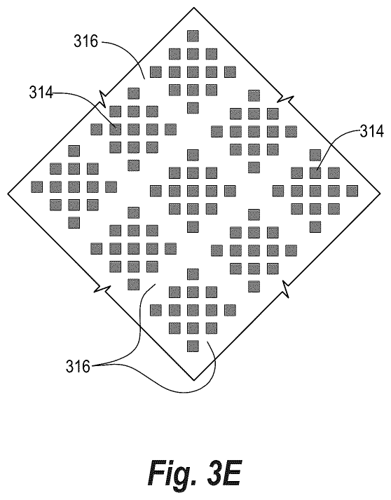

FIGS. 3A-3D illustrate various implementations of contact rollers for forming contact areas. For example, as shown in FIG. 3A, the contact rollers include a punch roll 302 and a cooperating die roll 304. Each of the punch roll 302 and the die roll 304 may be cylindrical and may have longitudinal axes that are parallel to each other. The punch roll 302 and the die roll 304 may define a passage or tooling nip therebetween through which film materials may pass through to form the contact areas. As shown in FIG. 3A, the punch roll 302 is provided with punch regions 308 and the die roll 304 is provided with corresponding die regions 306 for cooperating with, or receiving, the punch regions 308.

As illustrated in the enlargement shown in FIG. 3B, the punch regions 308 may each have a plurality of punch elements for cooperating with corresponding die elements in the die regions 306. The cooperating engagement of the punch elements with the die elements, with one or more thermoplastic films therebetween, forms contact areas by pressing thermoplastic films together.

FIG. 3C illustrates an alternative set of contact rollers comprise a punch roll 302 and a press roll 310. The press roll 310 may comprise a conformable surface for conforming to the punch elements, or other surface configuration of the punch roll 302. In still further embodiments, the press roll can comprise a rubber roll. FIG. 3D illustrates yet another implementation of contact rollers comprising two flat rolls.

In any event, one of the rolls may be formed from a relatively hard material (e.g., steel, aluminum, ebonite or other suitable hard material), and the other may be formed from a softer material (e.g., rubber or other suitable softer material). For example, the punch roll 302 and the cooperating die roll 304 may include a steel-to-rubber interface. In alternative embodiments, both the punch roll 302 and the die roll 304 may be formed from the relatively hard material (e.g., steel). Put another way, the punch roll 302 and the die roll 304 may include a steel-to-steel interface. Regardless of whether the punch roll 302 and the die roll 304 include a steel-to-rubber interface or a steel-to-steel interface, in one or more implementations, one or more of the contact rollers may include an electrically heated roll (e.g., means of heating). For example, in one embodiment, an aluminum punch roll 302 is internally heated by an electric source and a rubber die roll 304 is unheated. Alternatively, in at least one embodiment, at least one of the punch roll 302 and the die roll 304 may be externally heated (e.g., by directing a heat source at one or more outer portions of the roll). In alternative embodiments, neither of the contact rollers are heated.

The plurality of punch elements may have height of between about 10.0 mils and about 40.0 mils, and the receiving the die elements may have depth of between about 10.0 mils and about 40.0 mils. In at least one implementation, as shown in FIG. 3B, the punch elements and the correlating die elements can include a plurality of evenly spaced squares forming a repeat unit. In alternative implementations, the punch elements and the correlating die elements can include a plurality of evenly spaced chevron patterns. Alternatively, the punch elements and the correlating die elements can include a plurality of random polygon shaped protrusions and a plurality of matching random polygon shaped recesses to form a mosaic of random polygon shaped recesses.

Referring to FIG. 3E, a pattern formed by the contact rollers 302, 304 is illustrated in which each of the contact areas 314 in a flat portion of a portion of a reinforced thermoplastic bag with lofted regions is formed by a cooperating set of punch and die elements, and the remaining unformed areas define the separated areas 316 of the reinforced thermoplastic bag with lofted regions. As mentioned above, and as discussed further below, the contact areas 314 provide a visual impression with significant contrast to the reinforced thermoplastic bag with lofted regions. Additionally, as mentioned above, the contact areas 314 can increase a rigidity of the reinforced thermoplastic bag with lofted regions—thereby creating a sturdier and stronger feel in the areas of the reinforced thermoplastic bag with lofted regions including the contact areas 314.

In at least one embodiment, one or both of the contact rollers 302, 304 and/or the press roll 310 (as shown in FIGS. 3A-3D above) are heated to a temperature between 125 degrees and 324 degrees (Fahrenheit) in order to create the contact areas 314. Additionally, in at least one embodiment, the contact rollers 302, 304 and/or the press roll 310 may create the contact areas 314 by being positioned so as to create a tooling nip (e.g., a passage) where a multi-film thermoplastic structure passing therein experiences pressure within a range of 100-1800 pounds per square inch. Furthermore, the contact rollers 302, 304 and/or the press roll 310 may create the contact areas 314 by spinning at speeds of 500-1200 feet per minute. In one or more embodiments, the contact rollers 302, 304 and/or the press roll 310 may operate within these ranges of heat, pressure, and speed while processing a two-layer thermoplastic film, a four-layer thermoplastic film, an eight-layer thermoplastic film, or a multi-film thermoplastic structure with even more layers. In at least one embodiment, one or both of the contact rollers 302, 304 and/or the press roll 310 are pre-heated along the outer perimeter of the contact rollers 302, 304 and/or the press roll 310 to a temperature within the range described above. Additionally, or alternatively, the multi-film thermoplastic structure may be pre-heated prior to passing through the contact rollers 302, 304 and/or the press roll 310.

In any event, as the thermoplastic films passing through the contact rollers 302, 304 and/or the press roll 310 comprise a tension differential, when the films are released from tension, one film with rebound more than the other, thereby creating lofted regions.

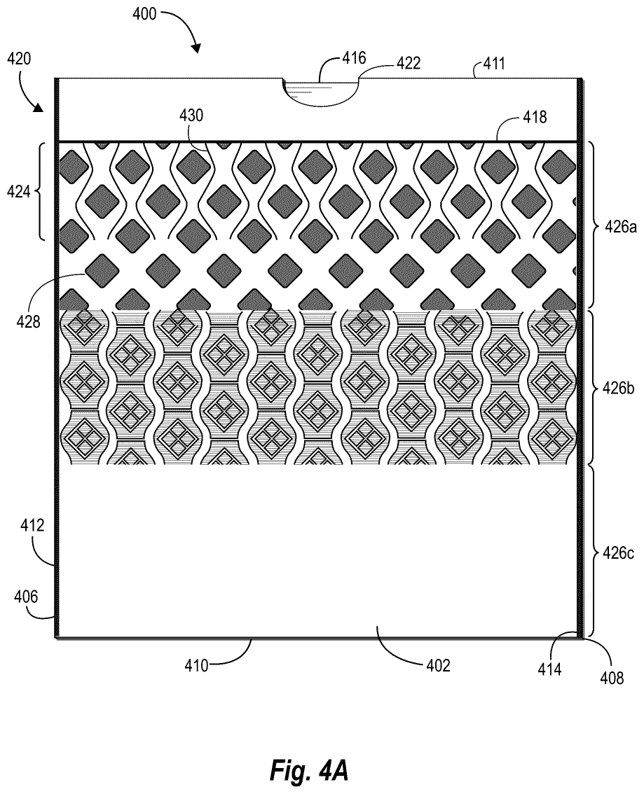

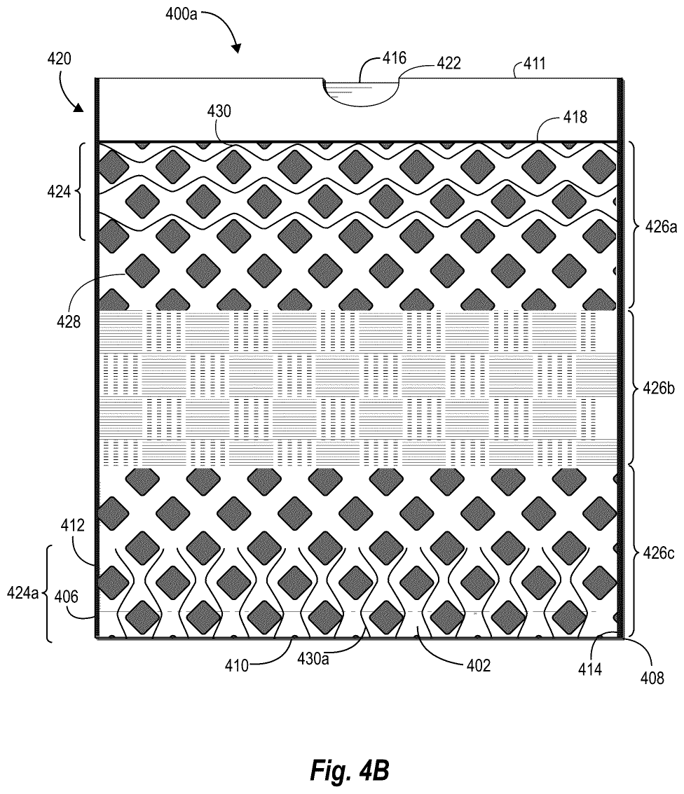

FIG. 4A is a perspective view of a reinforced thermoplastic bag 400 with lofted regions according to an implementation of the present disclosure. The reinforced thermoplastic bag 400 with lofted regions includes a first sidewall 402 and an opposite or opposing second sidewall that is a mirror image of the first sidewall 402. Each of the first and second sidewalls 402 includes a first side edge 406, a second opposite side edge 408, a bottom edge 410 extending between the first and second side edges 406, 408. Each of the first and second sidewalls 402 also includes a top edge 411 extending between the first and second side edges 406, 408 opposite the bottom edge 410. In some implementations, the first sidewall 402 and the second sidewall are joined together along the first side edges 406, the second opposite side edges 408, and the bottom edges 410. The first and second sidewalls 402 may be joined along the first and second side edges 406, 408 and bottom edges 410 by any suitable process such as, for example, a heated pressure seal. For example, FIG. 4A illustrates that side seals 412, 414 (e.g., heat seals) bond the first and second sidewalls 402 together at the side edges 406, 408. In alternative implementations, the first and second sidewalls 402 may not be joined along the side edges. Rather, the first and second sidewalls 402 may be a single uniform piece. In other words, the first and second sidewalls 402 may form a sleeve or a balloon structure.

In some implementations, the bottom edge 410 or one or more of the side edges 406, 408 can comprise a fold. In other words, the first and second sidewalls 402 may comprise a single unitary piece of material. The top edges 411 of the first and second sidewalls 402 may define an opening to an interior of the reinforced thermoplastic bag 400 with lofted regions. In other words, the opening may be oriented opposite the bottom edge 410 of the reinforced thermoplastic bag 400 with lofted regions. Furthermore, when placed in a trash receptacle (e.g., trash can), the top edges 411 of the first and second sidewalls 402 may be folded over the rim of the receptacle.

In some implementations, the reinforced thermoplastic bag 400 with lofted regions may optionally include a closure mechanism located adjacent to the top edges 411 for sealing the top of the reinforced thermoplastic bag 400 with lofted regions to form an at least substantially fully-enclosed container or vessel. As shown in FIG. 4A, in some implementations, the closure mechanism comprises a draw tape 416 with a hem channel 420 secured by a hem seal 418. In particular, the first top edge 411 of the first sidewall 402 may be folded over into the interior volume and may be attached or secured to an interior surface of the first sidewall 402 by the hem seal 418. Similarly, the second top edge of the second sidewall is folded over into the interior volume and may be attached to an interior surface of the second sidewall by a second hem seal. The draw tape 416 extends through hem channels created by the first and second hem seals 418 along the first and second top edges 411. The hem channels include apertures (e.g., notch) extending through the hem channel and exposing a portion of the draw tape 416. During use, pulling the draw tape 416 through the apertures 422 will cause the top edges 411 to constrict. As a result, pulling the draw tape 416 through the apertures 422 will cause the opening of the reinforced thermoplastic bag 400 with lofted regions to at least partially close or reduce in size. The draw tape closure mechanism may be used with any of the implementations of a multi-film thermoplastic bag described herein.

Although the reinforced thermoplastic bag 400 with lofted regions is described herein as including a draw tape closure mechanism, one of ordinary skill in the art will readily recognize that other closure mechanisms may be implemented into the reinforced thermoplastic bag 400 with lofted regions. For example, in some implementations, the closure mechanism may include one or more of flaps, adhesive tapes, a tuck and fold closure, an interlocking closure, a slider closure, a zipper closure, or any other closure structures known to those skilled in the art for closing a bag.

To strengthen the thermoplastic bag 400 (e.g., to reduce ruptures or punctures), the thermoplastic bag 400 may include a thermoplastic reinforcing strip 424. In particular, FIG. 4A shows that the thermoplastic bag 400 includes a reinforcement strip 424 and associated lofted regions 430 applied to at least a portion of the grab zone 426a. In these or other embodiments, the reinforcement strip 424 and associated lofted regions 430 can comprise one or more separate, strips/layers of material (e.g., a thermoplastic a film as described above) that may be attached to the thermoplastic bag 400 within the grab zone 426a or another area of the thermoplastic bag 400. In one or more embodiments, as shown in FIG. 4A, the reinforcement strip 424 with associated lofted regions 430 is non-continuously bonded (e.g., via a plurality of contact areas 428) to the first thermoplastic sidewall 402. Additionally, or alternatively, the reinforcement strip 424 with associated lofted regions 430 is attached to the first thermoplastic sidewall 402 via the side seals 412, 414 that join the first and second thermoplastic sidewalls along the first and second side edges 406, 408. Although not visible in FIG. 4A, another reinforcement strip 424 with associated lofted regions 430 may likewise be attached to the second thermoplastic sidewall.

In one or more implementations, the grab zone 426a for each of the first and second thermoplastic sidewalls span between an adjustable grab zone boundary and the hem seal 418. In addition, the grab zone 426a can span between the first and second side edges 406, 408. Accordingly, in one or more implementations the reinforcement strip 424 with associated lofted regions 430 extends between the side seals 412, 414 and coextensive with the grab zone 426a. In alternative implementations, the reinforcement strip 424 with associated lofted regions 430 does not extend the entire length between the side seals 412, 414 and/or does not span an entirety of the grab zone 426a. In any event, the reinforcement strip 424 with associated lofted regions 430 may provide extra material in the grab zone 426a (or another zone) of the thermoplastic bag 400 that may be more prone to failure.

The reinforcement strip 424 with associated lofted regions 430 has a width (e.g., distance that the reinforcement strip 424 with associated lofted regions 430 extends in a direction from the top edge 411 toward the bottom edge 410) in a first range of about 4 inch (2.54 cm) to about 40 inches (25.4 cm), a second range of about 3 inches (7.6 cm) to about 8 inches (20.3 cm), a third range of about 4 inches (10.2 cm) to about 6 inches (15.2 cm), a fourth range of about 40 inches (25.4 cm) to about 30 inches (76.2 cm), a fifth range of about 20 inches (50.8 cm) to about 48 inches (121.9 cm), a sixth range of about 23 inches (58.4 cm) to about 33 inches (83.8 cm), and a seventh range of about 26 inches (66 cm) to about 28 inches (71.1 cm). In one implementation, the width may be 5 inches (12.7 cm). In alternative implementations, the width may be shorter or longer than the examples listed above. In any event, the width for the reinforcement strip and associated lofted regions is less than a height of the reinforced thermoplastic bag 400.

By comparison, the height (distances from top edge 411 to bottom edge 410) of the reinforced thermoplastic bag 400 may have a first range of about 20 inches (50.8 cm) to about 48 inches (121.9 cm), a second range of about 23 inches (58.4 cm) to about 33 inches (83.8 cm), and a third range of about 26 inches (66 cm) to about 28 inches (71.1 cm). In one implementation, the height may be 25.375 inches (64.45 cm). In alternative implementations, the height of the reinforced thermoplastic bag 400 may be shorter or longer than the examples listed above.

In one or more embodiments, the first and second thermoplastic sidewalls 402 can have a greater thickness than the reinforcement strip 424 and associated lofted regions 430. In alternative implementations, the first and second thermoplastic sidewalls 402 and the reinforcement strip 424 with associated lofted regions 430 can each have the same thickness. In yet further implementations, the reinforcement strip 424 with associated lofted regions 430 can be thicker than the first and second thermoplastic sidewalls 402.

Additionally, or alternatively, in one or more embodiments, each of the first and second thermoplastic sidewalls 402 and the reinforcement strip 424 with associated lofted regions 430 can have a uniform or consistent gauge. In alternative implementations, one or more of the first and second thermoplastic sidewalls 402 and the reinforcement strip 424 with associated lofted regions 430 can be rough or uneven. Further, the gauge of one or more of the first and second thermoplastic sidewalls 402 and the reinforcement strip 424 need not be consistent or uniform. Thus, the gauge of one or more of the first and second thermoplastic sidewalls 402 and the reinforcement strip 424 can vary due to product design, manufacturing defects, tolerances, or other processing issues.

In particular, in one or more implementations, one or more of the first and second thermoplastic sidewalls 402 and the reinforcement strip 424 with associated lofted regions 430 is incrementally stretched. For example, in one or more implementations, one or more of the first and second thermoplastic sidewalls 402 and the reinforcement strip 424 with associated lofted regions 430 is incrementally stretched by one or more of MD ring rolling, TD ring rolling, SELFing, or other methods described in NON-CONTINUOUSLY LAMINATED MULTI-LAYERED BAGS of U.S. Patent Application No. 43/273,384, filed on Oct. 44, 2011 (hereafter “Fraser”), the contents of which are expressly incorporated herein by reference. Incrementally stretching one or more of the first and second thermoplastic sidewalls 402 and the reinforcement strip 424 can increase or otherwise modify one or more of the tensile strength, tear resistance, impact resistance, or elasticity of the films (while also reducing the basis weight of the film).

The first and second thermoplastic sidewalls 402 and the reinforcement strip 424 with associated lofted regions 430 can each comprise films of thermoplastic material. In particular, the first and second thermoplastic sidewalls 402 and the reinforcement strip 424 with associated lofted regions 430 can comprise any of the thermoplastic materials described above or combinations thereof. In one or more implementations, the first and second thermoplastic sidewalls 402 can comprise the same thermoplastic material as the reinforcement strip 424. In alternative implementations, the reinforcement strip 424 can comprise a different material than the first and second thermoplastic sidewalls 402. For example, the material of the reinforcement strip 424 may have a higher tensile strength, tear resistance, puncture resistance, elasticity, and/or abrasion resistance than the material of the first and second thermoplastic sidewalls 402. A reinforcement strip 424 made of stronger and/or tougher material may help further protect reinforced thermoplastic bag 400 against rupture and/or puncture. In other embodiments, the material of the reinforcement strip 424 with associated lofted regions 430 comprises recycled, non-virgin, or post-consumer reclaim thermoplastic materials.

In addition to the forgoing, in one or more implementations the reinforcement strip 424 with associated lofted regions 430 and the first and second thermoplastic sidewalls 402 can comprise visual features, such as color. In some cases, the visual features the of reinforcement strip 424 with associated lofted regions 430 and the first and second thermoplastic sidewalls 402 comprise a same color. In alternative implementations, the visual features (e.g., colors) of the reinforcement strip 424 with associated lofted regions 430 and the first and second thermoplastic sidewalls 402 can differ. For example, in one or more implementations, the first and second thermoplastic sidewalls 402 can comprise a white, translucent thermoplastic material. The reinforcement strip 424 with associated lofted regions 430 can comprise a pigmented (e.g., non-white or colored) material. For example, in one or more implementations, the reinforcement strip 424 with associated lofted regions 430 can comprise a black material. In such implementations, the areas of the reinforced thermoplastic bag 400 including the reinforcement strip 424 with associated lofted regions 430 can (if positioned between sidewall layers or on an inner surface of the first and second thermoplastic sidewalls 402) appear gray when viewed from at least one of an outside surface or an inside surface of the reinforced thermoplastic bag 400, as described above in relation to FIG. 3E.

For instance, when the reinforced thermoplastic bag 400 is placed inside a receptacle, an inside surface of the reinforced thermoplastic bag 400 is visible within the receptacle and/or as flipped over a top rim of the receptacle. In this configuration, the respective visual features (e.g., differing colors) of the reinforcement strip 424 with associated lofted regions 430 and the first and second thermoplastic sidewalls 402 may provide a visual signal of increased strength/durability through an inside surface of the reinforced thermoplastic bag 400. Similarly, when the reinforced thermoplastic bag 400 is held or viewed outside of a receptacle, an outside surface of the reinforced thermoplastic bag 400 is visible. In certain embodiments, the respective visual features (e.g., differing colors) of the reinforcement strip 424 with associated lofted regions 430 and the first and second thermoplastic sidewalls 402 may provide a visual signal of increased strength/durability through an outside surface of the reinforced thermoplastic bag 400. Thus, the differing color of the areas of the reinforced thermoplastic bag 400 including the reinforcement strip 424 with associated lofted regions 430 can serve to visually indicate to a consumer that such areas of the reinforced thermoplastic bag 400 are provided additional strength. By visibly including color in the reinforcement strip 424 with associated lofted regions 430 to show through one or more sidewall layers from outside and/or inside viewing perspectives, the reinforced thermoplastic bag 400 specifically addresses a current consumer perception of conventional thermoplastic liners that use less material being insufficiently strong.

Of course, the reinforcement strip 424 and associated lofted regions 430, like the reinforced thermoplastic bag 400, can include numerous other material/visual properties. For example, in one or more implementations, the reinforcement strip 424 with associated lofted regions 430 includes odor control additives, fragrance additives, etc. to improve and/or reduce an amount of foul odor, particularly in the grab zone 426a near the opening of the reinforced thermoplastic bag 400. These control additives, perfume additives, etc. in the grab zone 426a near the opening of the reinforced thermoplastic bag 400 can activate in response to stretching or grabbing of the reinforced thermoplastic bag 400 in these areas. Additionally, or alternatively, such control additives, perfume additives, etc. in the grab zone 426a near the opening of the reinforced thermoplastic bag 400 are positioned so as to exude (closest to a user's nose) a pleasant odor and/or quell (e.g., mask, render inert, etc.) unpleasant odors from garbage positioned below the grab zone 426a.

Additionally, or alternatively, in one or more embodiments, the reinforced thermoplastic bag 400 includes one or more patterned portions (e.g., a patterned hem seal, a patterned sidewall, a patterning of a plurality of contact areas 428, and/or a patterned reinforcement strip and associated lofted regions) that can serve to notify a consumer that such areas of the reinforced thermoplastic bag 400 are provided with additional strength. Like color, patterned portions selectively located at certain positions of the reinforced thermoplastic bag 400 (e.g., the reinforcement strip and associated lofted regions 430) specifically addresses a current consumer perception of conventional thermoplastic liners that use less material is insufficiently strong or durable. Of course, the patterned portions can be associated with a variety of material properties as described above. However, the pattern-enhancing visibility of these portions can be perceived as corresponding specifically to increased strength and durability.

As previously mentioned, the reinforcement strip 424 with associated lofted regions 430 can be non-continuously laminated to the reinforced thermoplastic bag 400. For example, FIG. 4A illustrates that the reinforced thermoplastic bag 400 can comprise a plurality of contact areas 428 securing the reinforcement strip 424 with associated lofted regions 430 to thermoplastic bag 400. In particular, the plurality of contact areas 428 may include a plurality of discontinuous bonds.

In one or more implementations, the plurality of contact areas 428 can have a bond strength that is less than a weakest tear resistance of each of the reinforced thermoplastic bag 400 and the reinforcement strip and associated lofted regions 430. In this manner, the plurality of contact areas 428 can be designed to fail prior to failing of the reinforced thermoplastic bag 400 or the reinforcement strip and associated lofted regions 430. Indeed, one or more implementations include the plurality of contact areas 428 that release just prior to any localized tearing of the reinforced thermoplastic bag 400 or the reinforcement strip and associated lofted regions 430. In particular, the plurality of contact areas 428 between the reinforced thermoplastic bag 400 and the reinforcement strip 424 with associated lofted regions 430 can act to first absorb forces via breaking of the plurality of contact areas 428 prior to allowing that same force to cause failure of the reinforced thermoplastic bag 400 or the reinforcement strip and associated lofted regions 430. Such action can provide increased strength to the reinforced thermoplastic bag 400.

This is beneficial as it has been found that thermoplastic films often exhibit strength characteristics that are approximately equal to the strength of the weakest layer. Providing relatively weak bonding between the reinforced thermoplastic bag 400 and the reinforcement strip 424 with associated lofted regions 430 has surprisingly been found to greatly increase the strength provided by the reinforcement strip and associated lofted regions 430. As more explicitly covered in U.S. Patent Application No. 42/947,025 filed Nov. 46, 2010, and entitled DISCONTINUOUSLY LAMINATED FILM, incorporated by reference herein, the MD and TD tear values of non-continuously laminated films in accordance with one or more implementations can exhibit significantly improved strength properties, despite a reduced gauge. In particular, the individual values for the Dynatup, MD tear resistance, and TD tear resistance properties in non-continuously laminated films of one or more implementations are unexpectedly higher than the sum of the individual layers. Thus, the non-continuous lamination of the reinforced thermoplastic bag 400 and the reinforcement strip 424 with associated lofted regions 430 can provide a synergistic effect.

More specifically, the TD tear resistance of the non-continuously laminated films can be greater than a sum of the TD tear resistance of the individual layers. Similarly, the MD tear resistance of the non-continuously laminated films can be greater than a sum of the MD tear resistance of the individual layers. Along related lines, the Dynatup peak load of the non-continuously laminated films can be greater than a sum of a Dynatup peak load of the individual layers. Thus, the non-continuously laminated films can provide a synergistic effect. In addition to the foregoing, one or more implementations of a non-continuously laminated reinforcement strip 424 with associated lofted regions 430 can allow for a reduction in basis weight (gauge by weight) as much as 50% in such areas of the reinforced thermoplastic bag 400 and still provide enhanced strength parameters.

As shown by FIG. 4A, the contact areas 428 can comprise diamond shapes. In alternative implementations, the contact areas can comprise alternative shapes, densities, sizes, etc. For example, the contact areas 428 can comprise squares, circles, ovals, stars, hexagons, or other shapes. As such, the use of diamond-shaped contact areas is for illustrative purpose and does not limit the implementations of the present invention.

In one or more implementations, the size, shape, and pattern of the bonding points (e.g., contact areas 428) dictate the shape and configuration of the lofted regions 430. For example, FIG. 4A illustrates that the lofted regions 430 comprise elongated pleats extending in transverse direction. Furthermore, as shown, in one or more implementations, the lofted regions 430 do not comprise straight lines. In other words, the lofted regions 430 are nonlinear. For example, as shown in FIG. 4A, the lofted regions comprise sinusoidal shapes to curve about the bonding points (e.g., contact areas 428). In alternative implementations, the lofted regions 430 comprise straight lines.

In one or more implementations, the thermoplastic bag 400 has a bag-in-bag structure. In other words, the thermoplastic bag 400 includes a first bag and a second bag positioned therein. More particularly, the first thermoplastic bag comprises first and second opposing sidewalls joined together along a first side edge, an opposite second side edge, and a closed first bottom edge. The second thermoplastic bag is positioned within the first thermoplastic bag. The second thermoplastic bag comprises third and fourth opposing sidewalls joined together along a third side edge, an opposite fourth side edge, and a closed second bottom edge. In one or more implementations, the first thermoplastic bag (e.g., the outer layer) is pigmented with a first color, and the second thermoplastic bag is pigmented with a second color (e.g., the inner layer is pigmented with the second color). As described above, the differing colors of the layers can allow for the creation of contact areas when the inner bag and the outer bag are placed into intimate contact.

As shown in FIG. 4A, the reinforced thermoplastic bag 400 with lofted regions includes a first region or grab zone 426a, a second region 426b, and a third region 426c. In the implementation shown, the first region 426a includes a pattern of contact areas 428. The pattern of contact areas shown in FIG. 4A includes a medium pattern density and exists on the outer and inner surfaces of the first and second sidewalls 402. Additionally, the first region 426a covers a portion of the reinforced thermoplastic bag 400 with lofted regions extending from the first hem seal 418 toward the bottom edge 410 of the reinforced thermoplastic bag 400 with lofted regions. Additionally, the pattern of contact areas is registered to the same location on the second sidewall of the reinforced thermoplastic bag 400 with lofted regions. The third region 426c of the reinforced thermoplastic bag 400 with lofted regions is a flat portion of the reinforced thermoplastic bag 400.

In one or more implementations, the second region 426b includes a pattern of deformations including at least one of raised rib-like elements in a strainable network or alternating thicker ribs and thinner stretched webs (e.g., SELF′ ed or ring rolled patterns). For example, as shown in FIG. 4A, the second region 426b includes elongated bulbs with nested diamonds of as described in International Patent Application No. PCT/US2018/058998 filed on May 16, 2019 and entitled “THERMOPLASTIC FILMS AND BAGS WITH COMPLEX STRETCH PATTERNS AND METHODS OF MAKING THE SAME,” hereby incorporated by reference in its entirety.

As shown by FIG. 4A, the elongated bulbs with nested diamonds pattern of deformations can comprise a repeating pattern of raised rib-like elements. In particular, the elongated bulbs with nested diamonds of deformations can include a first plurality of rib-like elements arranged pattern. Portions of the raised rib-like elements of the outer layer can be in direct contact and have the appearance of the inner of the bag 400. In contrast to the pattern of contact areas 428, however, the portions of deformations (e.g., raised rib-like element of a SELFing pattern or alternating thicker ribs and thinner stretched webs of a ring rolling pattern) stretch the film incrementally to create areas of varying gauge or thickness.

In one or more implementations, it is desirable to have more thermoplastic material in areas of the bag 400 (e.g., in the grab zones) that are often susceptible to tears, punctures, rips, or other failures. For example, the first region 426a lacks significant deformations and is otherwise less stretched relative to the second region 426b. The additional gauge can reinforce the first region 426a and help reduce failure. The pattern of contact areas 428 and the lofted regions 430 in the first region 426a provide the region with pleasing aesthetics, and visual and tactile cues of strength and durability.

The thermoplastic bag 400, as shown, includes side heat seals 412, 414 along the side edges 406, 408. As shown, the side heat seals can comprise areas in which all four or more layers of the thermoplastic bag are in intimate contact. As such, the side heat seal (and any other heat seals such as a hem seal) can have the same appearance as the contact areas. Heat seals differ from the contact areas in that the heat seals will not separate prior to failure of the thermoplastic films bonded by the heat seals.

While FIG. 4A shows lofted regions 430 only in the grab zone, one will appreciate that reinforcement strips with associated lofted regions can be positioned in various regions of the thermoplastic bag. For example, FIG. 4B illustrates a reinforced thermoplastic bag 400a, similar in most respects to the reinforced thermoplastic bag 400 of FIG. 4A, albeit that the reinforced thermoplastic bag 400a includes a second reinforcing strip 424a with associated lofted regions 430a positioned at the bottom of the reinforced thermoplastic bag 400a. In alternative implementations, the reinforcing strips with associated lofted regions are positioned in the center or second region 426b as well. In still further implementations, a reinforcing strip with associated lofted regions is positioned only at the bottom of the reinforced thermoplastic bag.

Additionally, the lofted regions 430 in the grab zone 426a of the reinforced thermoplastic bag 400a are oriented in the machine direction. In particular, as described above in relation to FIGS. 2A-2B, the lofted regions will extend in a direction perpendicular to the direction of strain applied prior to formation of the bonding points. Thus, the top reinforcing strip 424 of FIG. 4B was strained in the transverse direction, thereby, causing the lofted regions 430 to extend in the machine direction. In contrast, the lofted regions 430a extend in the transverse direction, signifying that the bottom reinforcing strip 424a of FIG. 4B was strained in the machine direction.

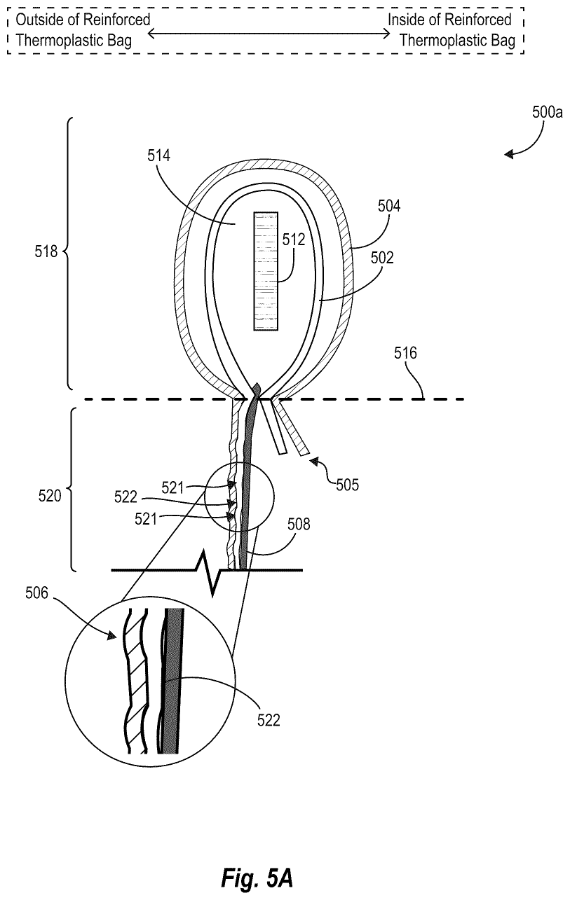

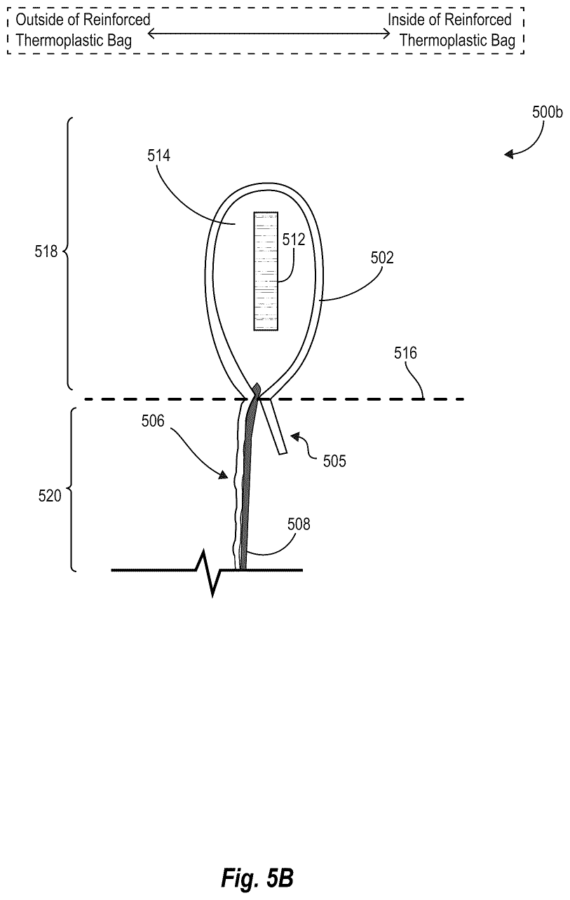

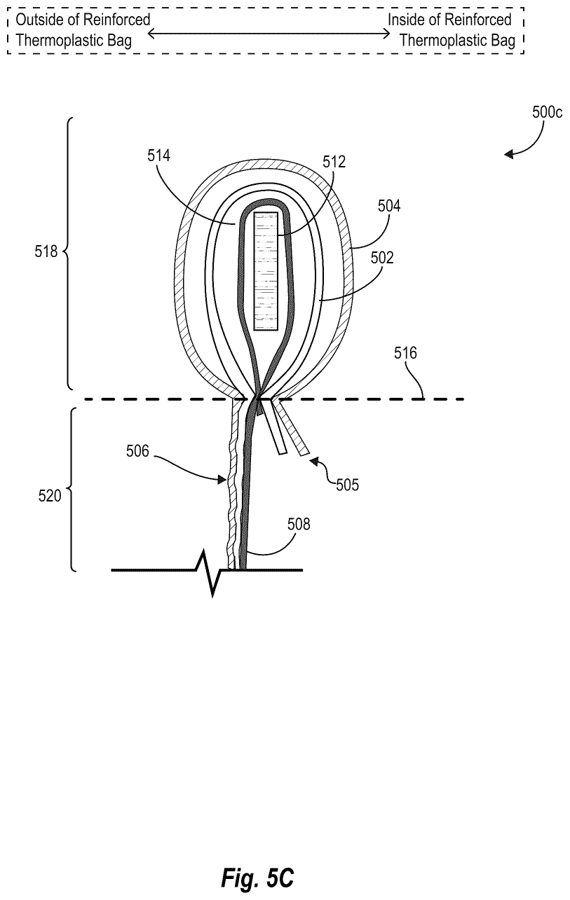

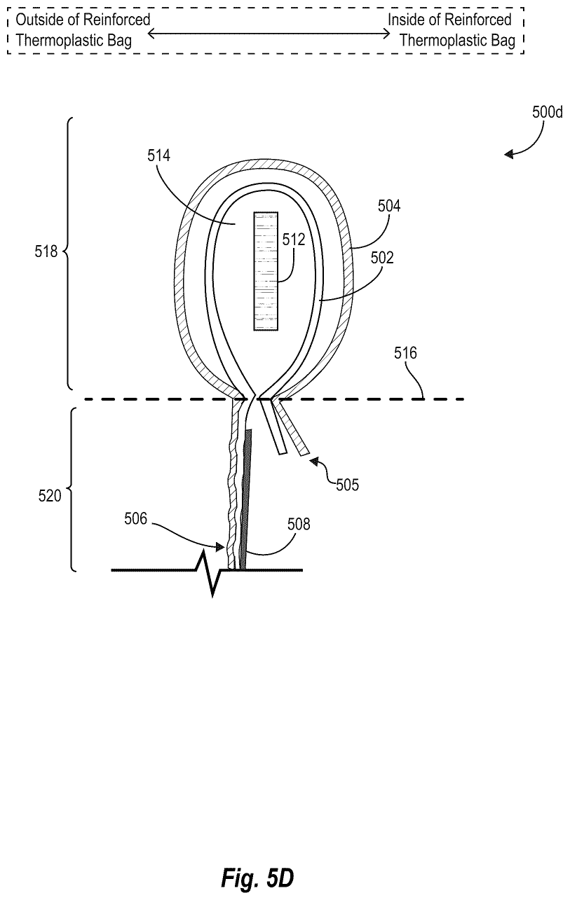

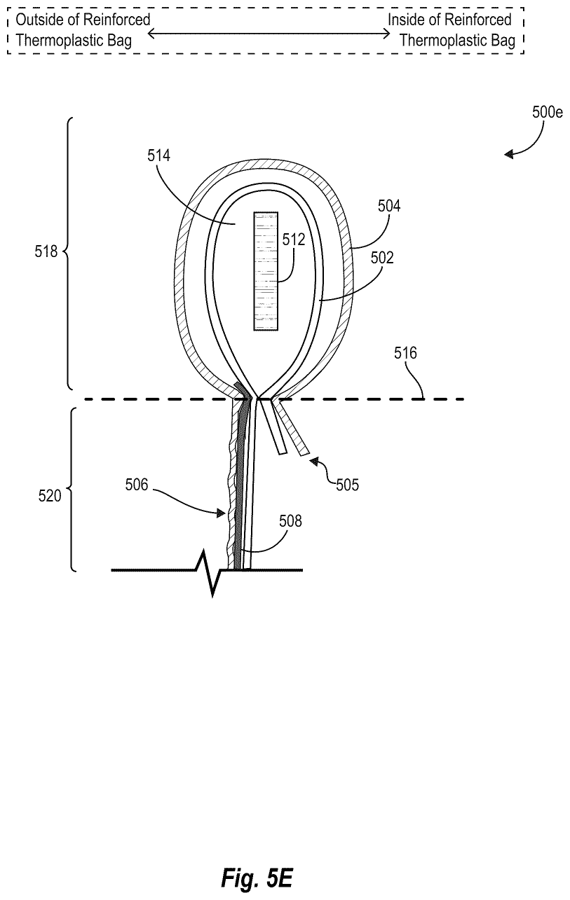

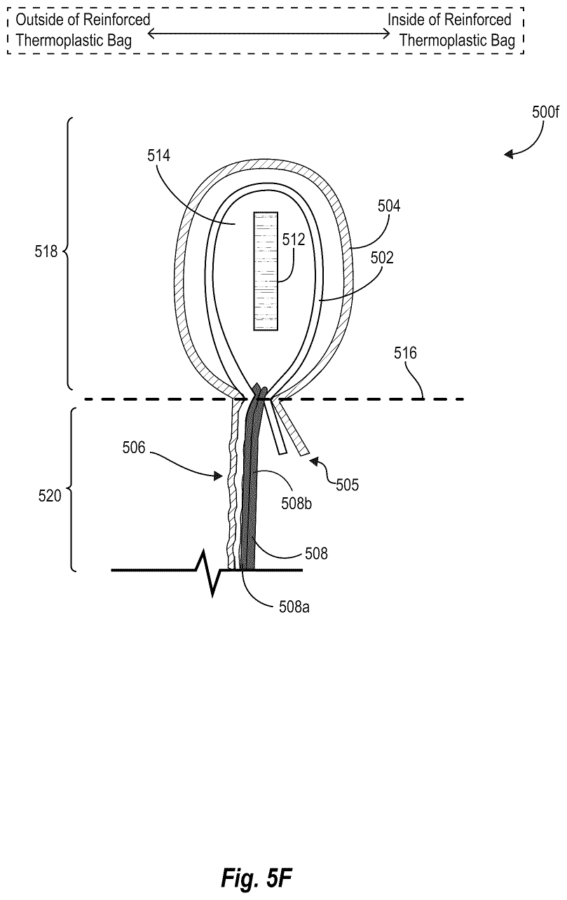

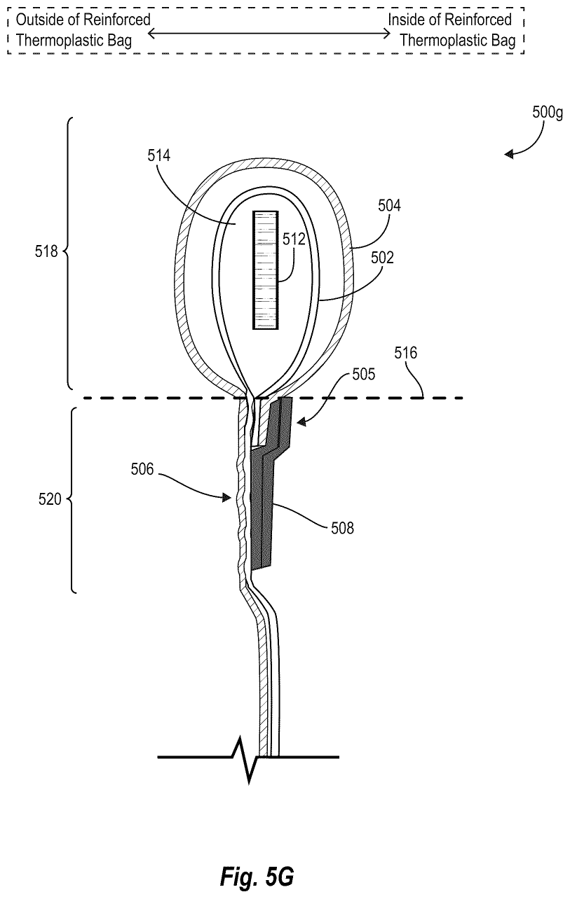

As mentioned above, a reinforcement strip and associated lofted regions can reinforce one or more thermoplastic sidewalls, including one or more layers and/or distinct bags (e.g., for a bag-in-bag). For example, FIGS. 5A-5G illustrate respective upper cross-sectional views of sidewalls 500a-500g including a reinforcement strip 508 with associated lofted regions 506 in accordance with one or more embodiments. Opposing sidewalls to the sidewalls 500a-500G are omitted for clarity of illustration (as are portions of a reinforced thermoplastic bag below a grab zone 520). Additionally, as indicated at the top of each of FIGS. 5A-5G, the sidewalls 500a-500G illustrate the outside of a reinforced thermoplastic bag to the inside of a reinforced thermoplastic bag in a left-to-right direction.

In one or more embodiments, the hem channel region 518 comprises a portion of the sidewalls 500a-500G above a hem seal (indicated by 516). In contrast, the grab zone 520 comprises another portion of the sidewalls 500a-500g extending below the hem seal 516 a distance toward a closed bottom edge (not shown). In particular, the hem seal 516 secures the fold-over of the top edge of the sidewalls 500a-500G to an inside surface of the reinforced thermoplastic bag, thereby forming a hem channel 514 and a corresponding hem skirt that terminates at the edge of the plies of thermoplastic film forming the sidewalls. Disposed within the hem channel 514 includes a draw tape 512.

In particular, FIGS. 5A-5G illustrate a positional relationship between the reinforcement strip 508 with associated lofted regions 506 and one or both of a first layer 502 and an optional second layer 504 of the sidewalls 500a-500g proximate a hem channel region 518 and/or the grab zone 520.

The reinforcement strip 508 with associated lofted regions 506 advantageously provides extra material for increased strength and durability at a portion of the grab zone 520 below (e.g., at least two to four inches) a hem skirt formed by a fold-over of a top edge of the sidewalls 500a-500g. Thus, where the hem skirt formed by the fold-over of the top edge is too short to provide adequate reinforcement to the grab zone 520, the reinforcement strip 508 with associated lofted regions 506 extends at least several inches below the hem skirt toward the bottom fold (not shown) for enhanced reinforcement coverage.

As shown for the sidewall 500a of FIG. 5A, the reinforcement strip 508 with associated lofted regions 506 is positioned against an inner side of the first layer 502 (e.g., an inner layer/bag) opposite the second layer 504 (e.g., an outer layer/bag) in the grab zone 520. Further, FIG. 5A shows the sidewall 500a includes the reinforcement strip 508 with associated lofted regions 506 extending across the grab zone 520 for additional reinforcement. In particular, the reinforcement strip 508 extends away from the hem seal 516, which it is laminated to the sidewall 500a. The reinforcement strip 508 with associated lofted regions 506 extending across the grab zone 520 provides an additional layer to strengthen the grab zone and help prevent tearing, puncturing, rips, or other undesired damage. Furthermore, the additional layer does not require alteration to the other traditional components of the reinforced thermoplastic bag such as the hem skirt. Thus, as explained above, placement/insertion of the folded reinforcement strip 508 with associated lofted regions 506 does not require retrofitting of conventional components of a bag making machine.

As mentioned above, in one or more implementations the reinforcing strip 508 with associated lofted regions 506 is secured to the inside surface of the reinforced thermoplastic bag (e.g., the inner surface of the first layer 502) using one or more bonds as described above. For example, FIG. 5A illustrates an embodiment in which the reinforcement strip 508 with associated lofted regions 506 is secured to the sidewall 500a by a plurality of contact areas 522. Thus, in one or more implementations contact areas 522 secure the layer(s) of the thermoplastic bag together with the reinforcement strip 508 in the grab zone. The contact areas 522 and lofted regions 521 they help reinforce the top-of-bag due to increased stiffness, and thereby, help reduce tearing or other damage by stresses/strain from grasping fingers (e.g., during a grabbing motion to lift or carry) applied to the grab zone. Additionally, the increased stiffness can provide a tactile feel that connotes strength to a user grasping the grab zone 520. Thus, by positioning the contact areas 522 and associated lofted region 521 in the grab zone 520, (a high-touch area) the contact areas 522 and lofted regions 521 provide tactile cues to the consumer about the strength and quality of the reinforced thermoplastic bag. More specifically, the contact areas 522 can comprise contact areas as described in International Application No. PCT/US2020/24145, filed on Mar. 25, 2020 and entitled: MULTI-FILM THERMOPLASTIC STRUCTURES AND BAGS HAVING VISUALLY-DISTINCT CONTACT AREAS AND METHODS OF MAKING THE SAME, which claims the benefit of and priority to U.S. Provisional Application No. 62/825,520, filed Mar. 28, 2019 and entitled: MULTI-FILM THERMOPLASTIC STRUCTURES AND BAGS HAVING VISUALLY-DISTINCT CONTACT AREAS AND METHODS OF MAKING THE SAME, the contents of the these two patent applications are hereby incorporated by reference in their entirety.

In one or more implementations, the reinforcement strip 508 can comprise a pigmented film and have a black appearance while the sidewall 500a (e.g., thermoplastic films 502 and 504) is substantially un-pigmented or lightly pigmented and have a clear, transparent, or cloudy appearance. When combined to form a reinforced thermoplastic bag in accordance the principles described herein, the contact areas 522 in the sidewall 500a can have a color or appearance that differs from the color of the rest of the sidewall 500a. For example, the sidewall 500a can have a metallic, silvery metallic or light grey color rather than a black appearance or color as would be expected (i.e., due to viewing the reinforcement strip 508 through a clear or transparent film). The regions or areas of the films in intimate contact with each other create contact areas that have a color or appearance that differs from the color or appearance of the sidewall 500a. For example, the contact areas 522 can have the color or appearance of the grab zone reinforcement structure (e.g., black). In one or more alternative implementations, the sidewall 500a comprises a light colorant while the reinforcement strip 508 comprises a dark colorant. A white colored sidewall 500a, when part of the reinforced thermoplastic bag can have a gray appearance. The foregoing described color change may give the appearance of a third color without requiring the actual colorant mixture of the third color to be within the reinforced thermoplastic bag. In other words, the bag can be devoid of a gray pigment. For example, it may allow a film having a viewable black layer and a viewable white layer to have (i.e., mimic) a gray appearance (often a consumer preferred color). Furthermore, the foregoing described color change may allow the film to mimic a gray appearance without significantly increasing and/or reducing a transparency (i.e., light transmittance) of the film. In other words, the foregoing described color change may allow the reinforced thermoplastic bag to mimic a gray appearance without detrimentally affecting an appearance of quality of the film.

Thus, the contact areas have a color or appearance that differs from the color or appearance of the sidewall 500a. For example, the contact areas 522 can have the color or appearance of the grab zone reinforcement structure (e.g., black) or another color. One will appreciate in light of the disclosure herein that black and white are used as exemplary colors for ease in explanation. In alternative embodiments, the films can comprise other color combinations such as white and blue, yellow and blue, red and blue, etc. Irrespective of the specific colors of the first and second thermoplastic films, the contact areas 522 can have a substantial change in appearance compared to the lofted regions 521 when viewed from the first thermoplastic film side of the reinforced thermoplastic bag. For example, the change in appearance of the contact areas 522 may include a perceivable change of color from gray to black. In additional embodiments, the change in appearance of the contact areas 522 may include a perceivable change of color from a first relatively lighter color to a second darker color. For example, the change in appearance may include perceivable change of color from a first light gray to a second dark gray. In other implementations, the change in appearance may include perceivable change of color from a first lighter version of any color to a second darker version of the same color.

Still, in other embodiments, the change in appearance of the contact areas 522 may include a perceivable change of color from a first relatively lighter color to a second lighter color. For example, the change in appearance may include perceivable change of color from a first white color to a second white color even brighter than the first white color. To illustrate, the grab zone 520 may appear (when viewed from the from the “white side”) extra white or lighter where a white-colored grab zone reinforcement structure is positioned between a 2-ply sidewall comprising one white ply and one black ply. Outside of the grab zone 520, however, the sidewall may appear grey due to the combination of white on black plies.

As another example, it may allow a film having a viewable blue layer (with a back yellow layer) to have (i.e., mimic) a green appearance. Furthermore, the foregoing described color change may allow the film to mimic a green appearance without significantly increasing and/or reducing a transparency (i.e., light transmittance) of the film. In other words, the foregoing described color change may allow the film to mimic a green appearance without detrimentally affecting an appearance of quality of the film. As a result of the foregoing, the multi-layer film of the present disclosure may provide a multi-layer film having a particular appearance (e.g., a green appearance) while reducing costs. One will appreciate that other color combination in addition to white/black producing grey and yellow/blue producing green are possible and the foregoing are provided by way of example and not limitation.

FIGS. 5A-5G illustrate implementations in which the reinforcement strip 508 was the more strained film at time of non-continuously bonding of the reinforcement strip 508 and the sidewall 500a. For example, as shown the reinforcement strip 508 is flat while the sidewall 500a includes the lofted regions 506. In one or more implementations, the lofted regions 506 are not visible when viewing the inside of the sidewall 500a. In alternative implementations, one or more thermoplastic films 502, 504 of the sidewall 500a is the more strained layer compared to the reinforcement strip 508 at the time of bonding. In such implementations the lofted regions 506 are created in the reinforcement strip 508 while the one or more thermoplastic films 502, 504 of the sidewall 500a are flat upon release of the strain differential.

While FIG. 5A illustrates a multi-layer reinforced thermoplastic bag (e.g., a bag-in-bag), alternative implementations include sidewalls having a single layer rather than multiple layers. For example, FIG. 5B further illustrates that the reinforced thermoplastic bag need not comprise a bag-in-bag or multi-layered configuration. In particular, as shown by FIG. 5B the reinforcement strip 508 and associated lofted regions 506 can reinforce a single layered bag. One with appreciate that many of the configurations of the reinforcement strip and associated lofted regions can equally be used with a single layer bag or a double layer bag. For example, FIG. 5B illustrates a configuration similar to that of FIG. 5A albeit with a single-layered reinforced bag. In particular, FIG. 5B shows the reinforcement strip 508 and associated lofted regions 506 reinforcing the grab zone 520 of a thermoplastic sidewall 500b. In this case, the first layer 502 forms a first, and only ply thermoplastic layer of the sidewall 500b. The reinforcement strip 508 forms a second, reinforcing layer in the grab zone 520.

In addition to reinforcing the grab zone 520, in one or more implementations the reinforcement strip 508 reinforces the hem channel. For example, FIG. 5C illustrates a sidewall 500c similar to the sidewall 500a of FIG. 5A albeit that the reinforcement strip 508 extends from the hem seal 516 and reinforces the hem channel 514. In particular, FIG. 5C shows a reinforcement strip 508 reinforcing the hem channel region 518 by extending around the hem channel 514. The reinforcement strip 508 forms an innermost layer bounding the hem channel 514. In addition, the first and second layers 502, 504 form second and third plies bounding the hem channel 514.

The portion of the reinforcement strip 508 bounding the hem channel 514 can reinforce the hem channel 514. In particular, when the draw tape 512 is pulled through drawtape notches the reinforcement strip 508 bounding the hem channel 514 can help reduce tearing of the hem channel 514 near the drawtape notches. Similarly, the reinforcement strip 508 bounding the hem channel 514 can help prevent tearing or puncturing when a user grabs the hem channel 514 while when removing the reinforced thermoplastic bag from a receptacle.

As described above, the contact areas 522 bond the reinforcement strip 508 to the sidewalls of the reinforced thermoplastic bag and create the lofted regions 521. FIGS. 5A-5C illustrate implementations in which the reinforcement strip 508 is additionally secured to the sidewalls of the reinforced thermoplastic bag via the hem seal 516. In alternative implementations, the reinforcement strip 508 is also secured to the reinforced thermoplastic bag via the side seals. In still further implementations, the reinforcement strip 508 is secured to the sidewalls by only the bonding points (e.g., contact areas 522). For example, FIG. 5D illustrates a sidewall 500d similar to the sidewall 500a of FIG. 5A albeit that the reinforcement strip 508 begins below the hem seal 516 and is bonded to the sidewall 500d by only the contact areas 522.

FIGS. 5A-5D illustrate implementations in which the reinforcement strip 508 is bonded to the inner side of the thermoplastic film 502. In alternative implementations, the reinforcement strip 508 is bonded to the outer side of the thermoplastic film 502, to the outer side of the thermoplastic film 504, or the inner side of the thermoplastic film 504. For example, FIG. 5E illustrates an implementation of a thermoplastic sidewall 500e similar to the thermoplastic sidewall 500a of FIG. 5A albeit that the reinforcement strip 508 is secured in between the thermoplastic films 502, 504. In particular, FIG. 5E shows the reinforcement layer 508a in between the first film 502 and the second film 504 by extending across the grab zone 520. More specifically, the reinforcement strip 508 is discontinuously bonded to the second film 504 by contact areas 522 that create lofted regions in the second film 504. In alternative implementations, the reinforcement strip 508 is positioned between the first and second thermoplastic films 502, 504 as shown by FIG. 5E but the reinforcement strip 508 is discontinuously bonded to the second film 504 and the first film 502 by contact areas 522.

FIGS. 5A-5E illustrate implementations in which the reinforcement strip 508 comprises a single layer. In alternative implementations, the reinforcement strip 508 comprises multiple layers. For example, FIG. 5F illustrates an implementation of a thermoplastic sidewall 500f similar to the thermoplastic sidewall 500a of FIG. 5A albeit that the reinforcement strip 508 comprises multiple layers. In particular, the reinforcement strip 508 of FIG. 5F comprises separate, discrete layers (e.g., a first reinforcement layer 508a and a second reinforcement layer 508b). For example, both the first reinforcement layer 508a and the second reinforcement layer 508b of the reinforcement strip 508 and associated lofted regions 506 extend a configurable distance (or different configurable distances) from below the hem seal 516 down towards a closed bottom edge (not shown). While FIG. 5F illustrates the reinforcement strip 508 and associated lofted regions 506 comprising two separate layers (first reinforcement layer 508 and second reinforcement layer 508b), in alternative implementations the reinforcement strip 508 and associated lofted regions 506 comprises a single layer partially folded, folded in half, folded multiple times, and/or folded at multiple ends.

In certain embodiments, the first reinforcement layer 508a and the second reinforcement layer 508b comprise differing colors to provide a different appearance compared to other portions of the sidewall 500f. Indeed, as mentioned above, a different colored portion in the grab zone 520 (such as a consumer-preferred color of grey) can provide visual cues to the consumer that the grab zone 520 is provided additional strength and reinforcement. For instance, in certain implementations, the first reinforcement layer 508a comprises a black-colored ply, and the second reinforcement layer 508b comprises a white-colored ply. Together, the first reinforcement layer 508a and the second reinforcement layer 508b of the reinforcement strip 508 and associated lofted regions 506 form a visibly gray portion of the sidewall 500f at an inside surface of the reinforced thermoplastic bag. Alternatively, other color variations may apply to the first reinforcement layer 508a and/or the second reinforcement layer 508b as desired.

In addition to reinforcing the grab zone 520, in one or more implementations the reinforcing strip 508 can also serve to bond the hem skirt 505 to the sidewall of the reinforced thermoplastic bag. For example, FIG. 5G illustrates an implementation of a thermoplastic sidewall 500g similar to the thermoplastic sidewall 500f of FIG. 5F albeit that the reinforcement strip 508 bonds the hem skirt to the sidewall 500g below the hem seal 516.

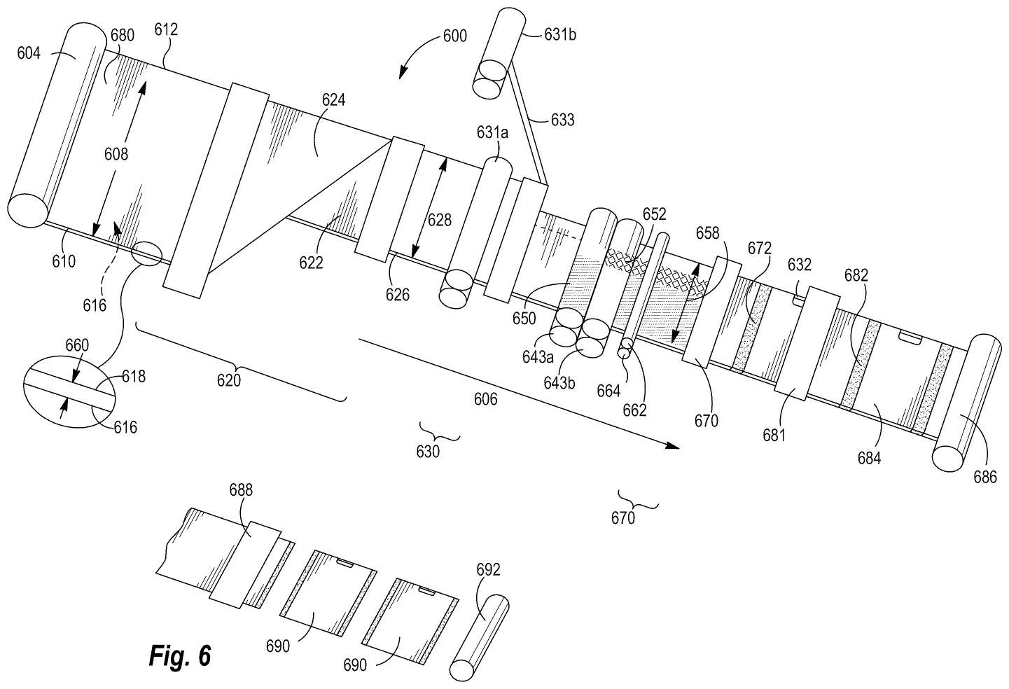

To produce a reinforced bag with lofted regions as described, continuous webs of thermoplastic material may be processed through a high-speed manufacturing environment such as that illustrated in FIG. 6. In the illustrated process 600, production may begin by unwinding a first continuous web or film 680 of thermoplastic sheet material from a roll 604 and advancing the web along a machine direction 606. The unwound web 680 may have a width 608 that may be perpendicular to the machine direction 606, as measured between a first edge 610 and an opposite second edge 612. The unwound web 680 may have an initial average thickness 660 measured between a first surface 616 and a second surface 618. In other manufacturing environments, the web 680 may be provided in other forms or even extruded directly from a thermoplastic forming process.

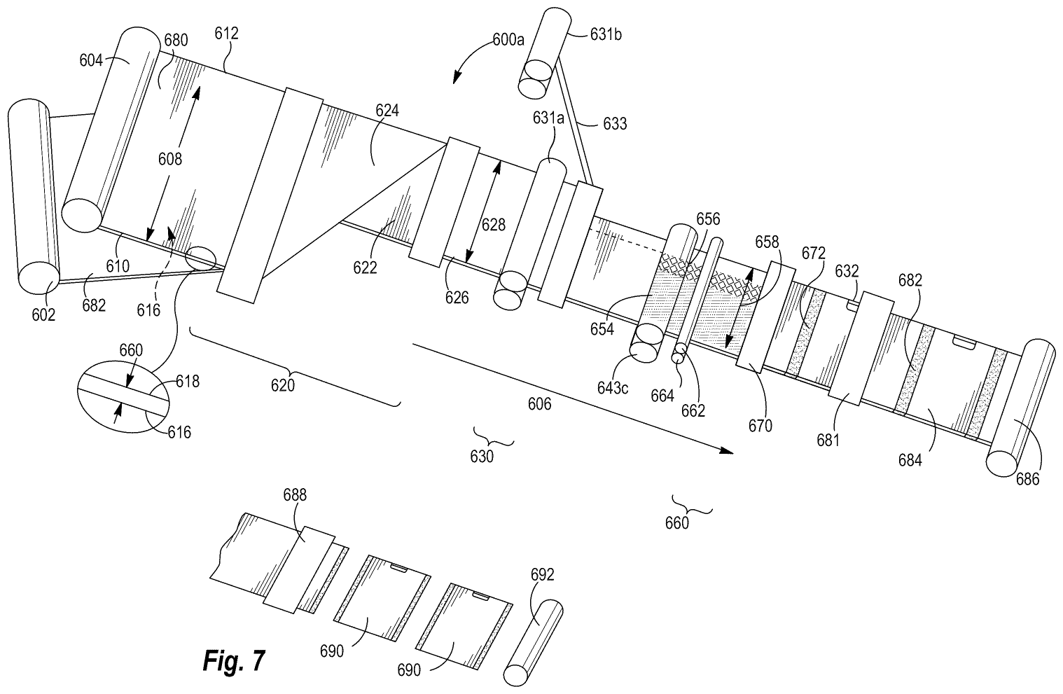

In some implementations, as shown in FIG. 7, the illustrated process 600a involves unwinding a second continuous web or film 682 of thermoplastic sheet material from a roll 602 and advancing the web along a machine direction 606. The second film 682 can comprise a thermoplastic material, a width, and/or a thickness that is similar or the same as the first film 680. In alternative one or more implementations, one or more of the thermoplastic material, width, and/or thickness of the second film 682 can differ from that of the first film 680. To provide the first and second sidewalls of the finished bag, the films 680, 682 may be folded into a first half 622 and an opposing second half 624 about the machine direction 606 by a folding operation 620. When so folded, the first edge 610 may be moved adjacent to the second edge 612 of the web. Accordingly, the width of the films 680, 682 proceeding in the machine direction 606 after the folding operation 620 may be a width 628 that may be half the initial width 608. As may be appreciated, the portion mid-width of the unwound films 680, 682 may become the outer edge of the folded films 680, 682.

The nip rollers 631a control the strain applied to the films 680, 682, which will respectfully become the sidewalls of the reinforced thermoplastic bag. Similarly, nip rollers 631b control the strain applied to the film 633 that will become the reinforcing strip. As mentioned above, one or more implementations involve creating a strain differential between the film 633 and the films 680, 682.

To form one or more regions of contact areas between the film 633 and the films 680, 682, the processing equipment may include at least one set of contact rollers 643b where at least one of the rolls is heated, such as those described herein above. Referring to FIG. 6, the folded web 680 may be advanced along the machine direction 606 between intermeshing rollers 643a (e.g., ring rolls, SELFing rollers, or embossing rollers), which impart a pattern 650 of elements in one portion, zone, area, or section of the resulting reinforced thermoplastic bag.

The folded web 680 and the film 633 may then advance through the contact rollers 643b, which impart a pattern 652 of contact areas and discontinuously bond the differentially strained film 633 and the films 680, 682. In one or more implementations, passing the folded web 680 between the set of heated contact rollers 643b creates one or more contact areas between flat portions of the folded web 680 and the film 633. As shown in FIG. 6, the pattern 650 of the intermeshing rollers 643a may be offset from the pattern 652 of the contact rollers 643b, such that the patterns imparted to the resulting reinforced thermoplastic bag do not overlap, or partially overlap depending on the offset.

As mentioned above, in one or more implementations, one of the contact rollers 643b is heated (e.g., a metal contact roller) while other contact roller is unheated (e.g., a rubber contact roller). In such implementations, having heat being applied to the one side of the films 680, 682, 633 can cause the contact areas on that heated side be more visually distinct (e.g., darker) and/or have more blocking between the layers on the headed side. Additionally, or alternatively, both of the rollers 643a, 643b may be heated rollers. For example, each of the rollers 643a, 643b may include a rubber roller (e.g., as a top or bottom roller) and a patterned roller.

In at least one embodiment, the processing equipment may include a vision system or sensor system in connection with one or more of the intermeshing rollers 643a and the contact rollers 643b. For example, the vision system or sensor system may detect pattern presence, placements, and darkness. Similarly, the sensor system may detect the TD placement of the film (e.g., similar to web breakout or guiding systems). Additionally, the processing equipment may include a force gauge probe to measure the drag of the film across the gauge between inner layers.

To avoid imparting a pattern (e.g., of contact areas or otherwise) onto the portion of the web that includes the draw tape 632, the corresponding ends of the rollers 643a, 643b may be smooth and without ridges, grooves, punch elements, or die elements. Thus, the adjacent edges 610, 612 and the corresponding portion of the web proximate those edges that pass between the smooth ends of the rollers 643a, 643b may not be imparted with any pattern. In alternative implementations, the intermeshing rollers (if present) and the contact rollers are after the drawtape insertion process.

The processing equipment may include pinch rollers 662, 664 to accommodate the width 658 of the web 680. The pinch rollers 662, 664 can control the strain applied to the bonded film 633 and the films 680, 682. For example, pinch rollers 662, 664 can release the strain differential maintained while the contact areas are formed. By so doing, the film 633, 680, 682 with the greater strain will rebound more creating lofted regions in the other film 633, 680, 682.

While FIGS. 6 and 7 illustrate the film 633 entering the processes 600, 600a after the folding operation 620, in alternative implementations the film 633 can be directed to enter the process 600 or 600a before the folding operation 620. In still further implementations, the film 633 enters the process 600 or 600a at another suitable position.

A hem channel may be formed by folding adjacent first and second edges 610, 612 over (e.g., at a top edge) and a draw tape 632 may be inserted into the hem channel during a hem channel and draw tape operation 630. In some implementations, as shown in FIGS. 6 and 7, the hem channel and draw tape operation 630 may fold over a length of the first and second edges 610, 612 such that a hem skirt is formed (e.g., indicated by the dashed line following the operation 630) down an inner surface of the reinforced thermoplastic bag.

To produce the finished bag, the processing equipment may further process the folded web with at least one region of contact areas. For example, to form the parallel side edges of the finished reinforced thermoplastic bag, the web may proceed through a sealing operation 670 in which heat seals 672 may be formed between the folded edge 626 and the adjacent edges 610, 612. The heat seals may fuse together the adjacent halves 622, 624 of the folded web. The heat seals 672 may be spaced apart along the folded web and in conjunction with the folded outer edge 626 may define individual bags. The heat seals may be made with a heating device, such as, a heated knife. A perforating operation 681 may perforate the heat seals 672 with a perforating device, such as, a perforating knife so that individual bags 690 may be separated from the web. In one or more implementations, the webs may be folded one or more times before the folded webs may be directed through the perforating operation 681. The web 680 embodying the bags 684 may be wound into a roll 686 for packaging and distribution. For example, the roll 686 may be placed in a box or a bag for sale to a customer.

In one or more implementations of the process, a cutting operation 688 may replace the perforating operation 681. The web is directed through a cutting operation 688 which cuts the webs into individual bags 690 prior to winding onto a roll 692 for packaging and distribution. For example, the roll 692 may be placed in a box or bag for sale to a customer. The bags may be interleaved prior to winding into the roll 692. In one or more implementations, the web may be folded one or more times before the folded web is cut into individual bags 690. In one or more implementations, the bags 690 may be positioned in a box or bag, and not onto the roll 692.

FIG. 7 illustrates a modified high-speed manufacturing 600a that involves unwinding a second continuous web or film 682 of thermoplastic sheet material from a roll 602 and advancing the web along a machine direction 606. The second film 682 can comprise a thermoplastic material, a width, and/or a thickness that is similar or the same as the first film 680. In alternative one or more implementations, one or more of the thermoplastic material, width, and/or thickness of the second film 682 can differ from that of the first film 680. The films 680, 682 can be folded together during the folding operation 620 such that they pass through the contact rollers 643c to form one or more regions of deformations and regions of contact areas in the resulting reinforced thermoplastic bags.

As shown by FIG. 7, the contact rollers 643c can comprise hybrid rollers with a first portion 656 that form contact areas and a second portion 654 that form deformations (e.g., ring rolling, SELFing, embossing). Furthermore, the contact rollers 643c are shown after the draw tape insertion process that also forms a hem skirt (e.g., indicated by the dashed line) by folding over a length of the first and second edges 610, 612. As mentioned above, passing layers of the first film 680 and the second film 682 between the contact rollers 643c creates one or more contact areas in a least one region between flat portions of the films 680, 682 and a hem skirt extending down an inner surface of the films 680, 682, where the one or more contact areas also extend from the hem channel over the hem skirt and toward bottom edges of the films 680, 682. In alternative implementations the contact rollers 643c can be positioned after the folding operation 620 or another position in the process 600a. For example, FIGS. 6 and 7 illustrate the rollers 643a, 643b, and 643c being position after the folding operation 620. In alternative implementations, the rollers 643a, 643b, 643c can be positioned before the folding operation 620. When positioned after the folding operation 620, one or more of the rollers 643a, 643b, 643c can create patterns of contact areas on opposing sides of the bag that are mirror images of each other.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A reinforced thermoplastic bag comprising:
first and second sidewalls extending between a first side edge and an opposing second side edge;
a top opening formed by the first and second sidewalls,
wherein the first and second sidewalls are connected along a bottom of the reinforced thermoplastic bag;
a first reinforcing strip discontinuously secured to the first sidewall by a first plurality of discontinuous lamination points;
a first plurality of lofted regions, in one of the first reinforcing strip or the first sidewall, between discontinuous lamination points of the first plurality of discontinuous lamination points;
a second reinforcing strip discontinuously secured to the second sidewall by a second plurality of discontinuous lamination points; and
a second plurality of lofted regions, in one of the second reinforcing strip or the second sidewall, between discontinuous lamination points of the second plurality of discontinuous lamination points.

2. The reinforced thermoplastic bag of claim 1, further comprising:
a first hem seal;
a first hem channel of the first sidewall, the first hem channel comprising a fold-over of a top edge of the first sidewall into the top opening of the first sidewall, the fold-over being secured to an inner surface of the first sidewall by the first hem seal, wherein a grab zone of the first sidewall extends from the first hem seal toward the bottom of the reinforced thermoplastic bag;
a second hem seal; and
a second hem channel of the second sidewall, the second hem channel comprising a fold-over of a top edge of the second sidewall into the top opening of the second sidewall, the fold-over being secured to an inner surface of the second sidewall by the second hem seal, wherein a grab zone of the second sidewall extends from the second hem seal toward the bottom of the reinforced thermoplastic bag;
wherein the first reinforcing strip is positioned across the grab zone of the first sidewall;
wherein the second reinforcing strip is positioned across the grab zone of the second sidewall.

3. The reinforced thermoplastic bag of claim 2, wherein:
the first reinforcing strip is secured to the reinforced thermoplastic bag by one or more of the first hem seal or side seals; and
the second reinforcing strip is secured to the reinforced thermoplastic bag by one or more of the second hem seal or the side seals.

4. The reinforced thermoplastic bag of claim 2, wherein the first reinforcing strip and the second reinforcing strip each comprise a first layer of thermoplastic material and a second layer of thermoplastic material.

5. The reinforced thermoplastic bag of claim 2, wherein the first reinforcing strip and the second reinforcing strip are positioned within the reinforced thermoplastic bag and extend across inner surfaces of the first sidewall and the second sidewall respectively.

6. The reinforced thermoplastic bag of claim 2, wherein the first plurality of lofted regions and the second plurality of lofted regions extend in a direction from the first side edge toward the opposing second side edge.

7. The reinforced thermoplastic bag of claim 2, wherein the first plurality of lofted regions and the second plurality of lofted regions extend in a direction from top opening toward the bottom of the reinforced thermoplastic bag.

8. The reinforced thermoplastic bag of claim 2, wherein the first reinforcing strip and the second reinforcing strip extend along the fold-overs of the first and second sidewalls and reinforce the first and second hem channels.

9. The reinforced thermoplastic bag of claim 1, wherein the first reinforcing strip and the second reinforcing strip are secured, respectively, to the first and second sidewalls exclusively via a bonding mechanism other than heat seals.

10. The reinforced thermoplastic bag of claim 1, wherein the first sidewall and the second sidewall each comprise a first layer of thermoplastic material and a second layer of thermoplastic material.

11. The reinforced thermoplastic bag of claim 1, wherein the first plurality of lofted regions and the second plurality of lofted regions provide elasticity to a top of the reinforced thermoplastic bag that allows the top of the reinforced thermoplastic bag to grip a receptacle within which the reinforced thermoplastic bag is placed.

12. A multi-layer thermoplastic bag comprising:
an outer thermoplastic bag comprising first and second opposing sidewalls joined together along a first side edge, an opposite second side edge, an open first top edge, and a closed first bottom edge;
an inner thermoplastic bag positioned within the outer thermoplastic bag, the inner thermoplastic bag comprising third and fourth opposing sidewalls joined together along a third side edge, an opposite fourth side edge, an open second top edge, and a closed second bottom edge,
wherein a hem seal secures a fold-over of the open first top edge and the open second top edge forming a hem channel;
a reinforcing strip discontinuously secured to at least one of the outer thermoplastic bag or the inner thermoplastic bag by a plurality of discontinuous lamination points; and
a plurality of lofted regions in at least one of the outer thermoplastic bag or the inner thermoplastic bag between discontinuous lamination points of the plurality of discontinuous lamination points.

13. The multi-layer thermoplastic bag of claim 12, wherein lofted regions of the plurality of lofted regions comprise a height between 1.5 and 10 times a sum of gauges of the outer thermoplastic bag and the inner thermoplastic bag.

14. The multi-layer thermoplastic bag of claim 12, wherein lofted regions of the plurality of lofted regions are nonlinear and curve around the discontinuous lamination points.

15. The multi-layer thermoplastic bag of claim 14, wherein the reinforcing strip is positioned closer to the closed first and second bottom edges than the open first and second top edges.

16. The multi-layer thermoplastic bag of claim 15, wherein the reinforcing strip is positioned either:
within the multi-layer thermoplastic bag and extends across an inside surface of the inner thermoplastic bag;
between the outer thermoplastic bag and the inner thermoplastic bag; or
outside of the multi-layer thermoplastic bag and extends across an outside surface of the outer thermoplastic bag.

17. The multi-layer thermoplastic bag of claim 12, wherein the reinforcing strip comprises one or more of a color or a thermoplastic material that differs from a color or thermoplastic material of one or more of the outer thermoplastic bag or the inner thermoplastic bag.

18. The multi-layer thermoplastic bag of claim 17, wherein the reinforcing strip comprises recycled, non-virgin, or post-consumer reclaim thermoplastic material.

19. The multi-layer thermoplastic bag of claim 12, wherein lofted regions of the plurality of lofted regions comprises air filled gaps between the reinforcing strip and the outer thermoplastic bag or the inner thermoplastic bag.

20. The multi-layer thermoplastic bag of claim 12, wherein the plurality of discontinuous lamination points comprise contact areas that are configured to separate before the reinforcing strip fails when subjected to peel forces and are flat and undeformed.
